(19) United States
(12) Patent Application Publication
(10) Pub. No.: US 2022/0067034 A1
(43) Pub. Date: Mar. 3, 2022

(54) COLLECTION, STRUCTURING, AND STORAGE OF PERSONAL DATA OF A USER OF AN ONLINE SERVICE

(71) Applicant: mePrism Inc., Carlsbad, CA (US)

(72) Inventor: Thomas Daly, New York, NY (US)

(21) Appl. No.: 17/458,069

(22) Filed: Aug. 26, 2021

Related U.S. Application Data
(60) Provisional application No. 63/071,270, filed on Aug. 27, 2020.

(51) Int. Cl. G06F 16/23; G06F 16/245; G06F 16/248

(52) U.S. Cl. CPC G06F 16/2379; G06F 16/248; G06F 16/245

(57) ABSTRACT

Computer architecture, computer-implemented instructions, input-processing-output (IPO), graphical user interfaces (GUIs), databases, and file management including a method, system and non-transitory computer-readable storage medium (CRM) storing at least one program for collecting, structuring, and storing personal data of a user of an online service. The method, system and CRM includes: collecting the personal data of the user from the online service; structuring the collected personal data; storing the structured collected personal data in a structured unitary data structure, wherein the structured unitary data structure is configured to store at least one of the following: customer data, search engine data, social media data, contract customer data, enterprise customer data, and contract data; querying the structured unitary data structure; and transmitting a signal based on the query. Related devices, apparatuses, systems, techniques, articles and non-transitory computer-readable storage media are also described.

### CROSS-REFERENCE TO RELATED APPLICATIONS

The present application claims priority to U.S. Provisional Patent Appl. No. 63/071,270, filed Aug. 27, 2020, and entitled “Computer Architecture, Computer-Implemented Instructions, Input-Processing-Output, Graphical User Interfaces, Databases And File Management For Collecting, Structuring, And Storing Personal Data Of A User Of An Online Service”, and incorporates its disclosure herein by reference in its entirety.

### TECHNICAL FIELD

The present disclosure relates to computer architecture, computer-implemented instructions, input-processing-output (IPO), graphical user interfaces (GUIs), databases, and file management.

### BACKGROUND

From an individual or user standpoint, downloading personal data from various Internet websites is a problematic, high-friction and laborious process that often requires several operations. Individuals without data science training or tools are not able to organize or visualize their personal data in a meaningful way. Such individuals do not have access to data brokerage markets and therefore cannot sell their personal data for profit. Such individuals do not control their personal data themselves; therefore, businesses interested in buying personal data cannot buy personal data directly from such individuals. Also, such businesses cannot purchase data in a manner compliant with data protection regulations such as the European General Data Protection Regulation (GDPR) or California Consumer Privacy Act (CCPA). GDPR and CCPA require that businesses obtain consent from an individual before buying or selling their personal data. Such individuals do not have all the information necessary about their personal data to make an informed decision about how to value their data or who to sell it to. Without understanding what data companies collect, and how that data can be used, it is practically impossible for such individuals to give informed consent to the use of their personal data. Such individuals do not have clear alternatives to relinquishing control of their personal data. Many internet services are so core to daily life that avoiding their use would be socially or commercially unviable. GDPR and CCPA require that companies with personally identifiable information (PH) allow individuals to request a copy of their information, and send them a usable file of that information if requested. Individuals often do not determine what data is collected about them, and are forced to choose between consenting to the use of all of their data or preventing the use of any data. Many individuals are unaware of how their personal data can be used to predict qualities that are not actually included in their personal data. Many individuals are not aware of the different companies that are purchasing their data directly or indirectly every day, and the magnitude of these purchases. Finally, individuals are susceptible to being negatively (or positively) influenced by targeted advertisements from companies, politicians, or others.

### SUMMARY

In some implementations, the current subject matter relates to a system for collecting, structuring, and/or storing personal data of a user of an online service is provided. The system may include a device. The device may include at least one processor and a memory storing at least one program for execution by the at least one processor. At least one program may include instructions, when, executed by the processor cause the processor to perform one or more of the following operations.

In some implementations, the operations may include collecting the personal data of the user from the online service. The operations may include structuring the collected personal data. The operations may include storing the structured collected personal data in a structured unitary data structure. The structured unitary data structure is configured to store at least one of the following: customer data, search engine data, social media data, contract customer data, enterprise customer data, and contract data. The operations may include querying the structured unitary data structure. The operations may include transmitting a signal based on the query.

In some implementations, the current subject matter may include one or more of the following optional features. The structured unitary data structure may be configured to interrelate at least two of the following: the customer data, the search engine data, the social media data, the contract customer data, the enterprise customer data, and the contract data.

In some implementations, the structured unitary data structure may be configured to store customer meta data. The structured unitary data structure may be configured to aggregate customer information. The structured unitary data structure may be configured to track a state of activity at any point within an architecture. The structured unitary data structure may be configured to provide relatively flexible access patterns and document structure. The structured unitary data structure may be configured to control structure, indexing, and reliability. The structured unitary data structure may comply with an industry standard. The structured unitary data structure may be configured for loose coupling, high cohesion, and without multi-collection operational access. The structured unitary data structure may be configured to keep data from third party sources separate from other internal and third party sources. The structured unitary data structure may be configured to separate data lake structures from operational data structures. The structured unitary data structure may be configured to maintain high cohesion and close data relation in the unitary data structure. The structured unitary data structure may be configured to balance the high cohesion with the loose coupling. The structured unitary data structure may be configured to give a higher priority to the loose coupling relative to the high cohesion. The structured unitary data structure may be configured to avoid access of operational services to more than one collection directly. In some implementations, the structured unitary data structure may include at least one of the following a customer master database, a first online service takeout database, a second online service takeout database, a contract customer database, an enterprise data customer database, and a contract database.

In some implementations, the structured unitary data structure may include a one-to-many relationship.

In some implementations, the structured unitary data structure may include the customer master database in the one-to-many relationship between the first online service takeout database. The structured unitary data structure the customer master database in the one-to-many relationship with the second online service takeout database. The structured unitary data structure may include the customer master database in the one-to-many relationship with the contract customer database. The structured unitary data structure may include the enterprise data customer database in the one-to-many relationship with the contract customer database. The structured unitary data structure may include the enterprise data customer database in the one-to-many relationship with the contract database.

In some implementations, the structured unitary data structure may include a primary key, and a foreign key.

In some implementations, the system may prompt the user for access to the online service. The system may include accessing the online service on behalf of the user.

In some implementations, the structuring of the collected personal data may include an analysis of one or more portions of the personal data of the user from the group consisting of social media, personality, finance, location, and health. The system may display to the user an option to access the analysis of the at least one of the following the social media, the personality, the finance, the location, and the health.

In some implementations, the system may analyze the collected personal data. The system may further calculate a data score based on the analyzed collected personal data; and displaying the data score. The calculation of the data score based on the analyzed collected personal data may be based on a volume factor based on a size of the personal data of the user from the online service.

The online service may be a plurality of online services. In some implementations, the calculation of the data score based on the analyzed collected personal data may be based on a variety factor based on the number of the plurality of online services. The calculating of the data score based on the analyzed collected personal data may be based on an account history factor based on an age of the personal data of the user from the online service. The calculating of the data score based on the analyzed collected personal data may be based on a psychometric factor based on user responses to questions.

In some implementations, the online service may include a plurality of online services. The plurality of online services may include at least one of the following: a financial service, a location service, a social media service, and a search engine. The calculation of the data score based on the analyzed collected personal data may be based on a weighted average of points for each of plurality of online services. The calculation of the data score based on the analyzed collected personal data may be based on a simulator configured to display to the user a new data score based on addition of a new online service. The data score may be a numeric value. The data score may be a numeric value between 0 and 1000. The data score may be a numeric value between 400 and 850. The data score may be displayed with a color coded graphic. The data score may be displayed with a meter. The meter may include a numeric range corresponding with the data score.

In some implementations, the system may display to the user an option to sell at least one portion of the analyzed collected personal data based on the data score. The system may prompt the user to accept a license to a buyer of at least one portion of the analyzed collected personal data. The system may calculate a value of the analyzed collected personal data based on the data score. The system may transmit an offer for sale of at least one portion of the analyzed collected personal data to an entity other than the user. The system may receive from an entity other than the user a bid for purchase of at least one portion of the analyzed collected personal data; and transmit the bid to the user. The system may receive from a plurality of advertisers bids for purchase of at least one portion of the analyzed collected personal data; and display to the user a grid comparing the bids from the plurality of advertisers.

In some implementations, the system may render content to the user based on the analyzed collected personal data. The system may render emotional content to the user based on emotional data extracted from the analyzed collected personal data. The system may render emotional content to the user based on emotional data extracted from the analyzed collected personal data including display of at least one portion of the personal data corresponding with the rendered emotional content. The system may render a virtual footprint to the user based on the analyzed collected personal data. The virtual footprint may include personal information regarding the user extracted from the analyzed collected personal data. The virtual footprint may include content based on information the user shares, content based the personal data that suggests attributes of the user, and content derived from a machine analysis of the personal data. The virtual footprint may include content based on at least one of the following gender, search terms, friends, user name, likes, reactions, photos, real name, ethnicity, religious views, intelligence quotient, self-esteem, mental illness, psychometric profile, gambling, visited websites, advertisements, global positioning system, shopping patterns, typing speed, clicks, articles, posts, timestamps.

In some implementations, the system may prompt the user to verify an accuracy of information based on the analyzed collected personal data.

In some implementations, the system may render a data dose to the user. The data dose may include a prediction based on the analyzed collected personal data.

In some implementations, the system may render a daily activity summary to the user. The data activity summary may include a heat map including data corresponding with at least one of the following a day of the week, a time of the day, a geographic location, and a mode of transportation.

In some implementations, the current subject matter relates to a method for collecting, structuring, and storing personal data of a user of an online service. The method may include one or more operations discussed herein, including, but not limited to, the operations discussed above.

In some implementations, the current subject matter relates to a non-transitory computer-readable storage medium storing at least one program for collecting, structuring, and storing personal data of a user of an online service. The program may be executed by at least one processor and a memory that may store the program. The program may include instructions, when, executed by the processor cause the processor to perform one or more operations. The method may include one or more operations discussed herein, including, but not limited to, the operations discussed above.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram of an exemplary architecture of a system, according to some implementations of the current subject matter;

FIG. 2 is a diagram of an exemplary sign in flow, according to some implementations of the current subject matter;

FIG. 3 is a diagram of an exemplary federated sign in flow, according to some implementations of the current subject matter;

FIG. 4 is a diagram of an exemplary structured data model, according to some implementations of the current subject matter;

FIG. 5 is a diagram of an exemplary user data access flow, according to some implementations of the current subject matter;

FIG. 6 is a diagram of an exemplary process takeout file flow, according to some implementations of the current subject matter;

FIG. 7 is a diagram of an exemplary subscribe to professional (pro) version flow, according to some implementations of the current subject matter;

FIG. 8 is a diagram of an exemplary customer sells data to partner flow, according to some implementations of the current subject matter;

FIG. 9 is a diagram of an exemplary develop, test and deploy flow, according to some implementations of the current subject matter;

FIG. 10 is a flow chart of an exemplary method for collecting, structuring, and/or storing personal data of a user of an online service, according to some implementations of the current subject matter;

FIG. 11 is a schematic diagram of an exemplary computer device and/or system including at least one processor and a memory storing at least one program for execution by the processor, according to some implementations of the current subject matter;

FIG. 12a is an exemplary “who they think you are” virtual footprint graphical user interface (GUI) screen, according to some implementations of the current subject matter;

FIG. 12b is an exemplary “who your data suggests you are” virtual footprint GUI screen, according to some implementations of the current subject matter;

FIG. 12c is another exemplary “who they (the machine(s)) think you are” virtual footprint GUI screen, according to some implementations of the current subject matter;

FIG. 13 is an exemplary GUI screen illustrating various data categories, according to some implementations of the current subject matter;

FIG. 14 is an exemplary data health score GUI screen, according to some implementations of the current subject matter;

FIG. 15a is an exemplary data health score activity GUI screen, according to some implementations of the current subject matter;

FIG. 15b is an exemplary data health score predictor GUI screen, according to some implementations of the current subject matter;

FIG. 15c is another exemplary data health score predictor GUI screen, according to some implementations of the current subject matter;

FIG. 15d is yet another exemplary data health score predictor GUI screen without a call to action (CTA), according to some implementations of the current subject matter;

FIG. 15e is yet another exemplary data health score predictor GUI screen with a bank CTA, according to some implementations of the current subject matter;

FIG. 15f is a further exemplary data health score predictor GUI screen with a personality test CTA, according to some implementations of the current subject matter;

FIG. 15g is a yet another exemplary data health score predictor GUI screen with several CTAs, according to some implementations of the current subject matter;

FIG. 16 is an exemplary data volume GUI screen, according to some implementations of the current subject matter;

FIG. 17 is an exemplary data volume GUI screen, according to some implementations of the current subject matter;

FIG. 18 is an exemplary data volume GUI screen, according to some implementations of the current subject matter;

FIG. 19 is an exemplary location data volume GUI screen, according to some implementations of the current subject matter;

FIG. 20 is an exemplary data volume GUI screen, according to some implementations of the current subject matter;

FIG. 21 is an exemplary account variety GUI screen, according to some implementations of the current subject matter;

FIG. 22 is an exemplary account history GUI screen, according to some implementations of the current subject matter;

FIG. 23 is an exemplary financial summary GUI screen, according to some implementations of the current subject matter;

FIG. 24 is another exemplary financial summary GUI screen with sliding cards, according to some implementations of the current subject matter;

FIG. 25 is an exemplary daily spending GUI screen, according to some implementations of the current subject matter;

FIG. 26 is an exemplary financial habits GUI screen, according to some implementations of the current subject matter;

FIG. 27 is an exemplary financial timeframe (monthly) GUI screen, according to some implementations of the current subject matter;

FIG. 28 is an exemplary financial timeframe (weekly) GUI screen, according to some implementations of the current subject matter;

FIG. 29 is another exemplary financial timeframe (weekly) GUI screen, according to some implementations of the current subject matter;

FIG. 30 is yet another exemplary financial timeframe (weekly) GUI screen, according to some implementations of the current subject matter;

FIG. 31 is an exemplary daily activity heat map GUI screen, according to some implementations of the current subject matter;

FIG. 32 is an exemplary hotspot location GUI screen without the popup, according to some implementations of the current subject matter; and

FIG. 33 is an exemplary data volume home GUI screen, according to some implementations of the current subject matter.

It is noted that the drawings are not necessarily to scale. The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting exemplary embodiments and that the scope of the present invention is defined solely by the claims.

### DETAILED DESCRIPTION

A computer architecture, computer-implemented instructions, IPOs, GUIs, databases and file management allow consumer customers (also referred to herein as consumers, customers, individuals or users) to collect their personal data, give consumer customers tools to understand what that data is and how the data can be used, and allow consumer customers to sell their data in a GDPR and CCPA compliant marketplace if they choose.

The computer architecture, computer-implemented instructions, IPOs, GUIs, databases and file management allow customers to download their personal data files from companies including Google, Facebook, Instagram, and financial institutions, and store this data for customers securely in one place.

The computer architecture, computer-implemented instructions, IPOs, GUIs, databases and file management processes and organize customer's data into a structured database so that the data can be effectively used. Using the structured data, the computer architecture, computer-implemented instructions, IPOs, GUIs, databases and file management present personalized content to a customer with the intention of informing that customer what data is included from each of these sources, how that data can be used, and the overall value of their data.

The computer architecture, computer-implemented instructions, IPOs, GUIs, databases and file management connect businesses interested in buying personal data with users, so that users can sell their personal data for profit if they choose.

The computer architecture, computer-implemented instructions, IPOs, GUIs, databases and file management allow businesses to buy personal data in a manner compliant with GDPR and CCPA since businesses are buying personal data directly from the individual with consent.

The computer architecture, computer-implemented instructions, IPOs, GUIs, databases and file management create an immutable ledger detailing every transaction and its consent for auditing purposes.

The computer architecture, computer-implemented instructions, IPOs, GUIs, databases and file management provide customers with all the information necessary to give informed consent to the use of their personal data.

The computer architecture, computer-implemented instructions, IPOs, GUIs, databases and file management allow customers to continue using internet services that collect personal data, without relinquishing control of their data.

The computer architecture, computer-implemented instructions, IPOs, GUIs, databases and file management provide compliance solutions to companies with PII through an application programming interface (API) access so that customers can request and receive their personal information from that company.

The computer architecture, computer-implemented instructions, IPOs, GUIs, databases and file management allow customers to sell one or more portions of their data portfolio, and allow companies to buy one or more portions of customer's personal data.

The computer architecture, computer-implemented instructions, IPOs, GUIs, databases and file management produce GUIs that effectively show customers how their data can be used to predict qualities that are not explicitly included in their data.

The computer architecture, computer-implemented instructions, IPOs, GUIs, databases and file management provide customers with a list of the companies that have directly or indirectly purchased their data, and an estimate of a total value their data has accrued for other companies.

The computer architecture, computer-implemented instructions, IPOs, GUIs, databases and file management show individuals a list of the companies that have bought their data so that they are more aware of how those companies may try to influence them through targeted advertisements.

The computer architecture, computer-implemented instructions, IPOs, GUIs, databases and file management present customers with several features and terms in order to aid with the collection, understanding, and valuation of their data.

Data Score

The computer architecture, computer-implemented instructions, IPOs, GUIs, databases and file management may calculate and display a data score to help customers quantify a value of their data. The computer architecture, computer-implemented instructions, IPOs, GUIs, databases and file management may calculate a customer's data score by measuring an amount of the customer's accurate virtual footprint data within the system. The data score may be associated with a number on a scale. The scale may be, for example, 400 to 850. A higher score may correlate to a higher value of that customer's data; therefore, a customer who increases their data score may receive higher and more frequent bids for their data.

Data Bank

The computer architecture, computer-implemented instructions, IPOs, GUIs, databases and file management may provide a data bank account to help customers understand an importance and value of securely storing their personal data. Although data is digital, data, especially personal data, is a highly valuable asset with value and personal significance. The computer architecture, computer-implemented instructions, IPOs, GUIs, databases and file management treat data, especially personal data, in a manner similar to hard assets, cash, jewelry, or other personal possessions that warrant secure protection. The data bank account may be configured to display to customers the accounts associated with their collected data. The data bank account may be configured to display a total amount of collected data. The data bank account may be configured to display to the customer a view of the data stored. The data bank account may be configured to display information regarding additional deposits of new personal data. The data bank account may be configured to prompt the customer to make “withdrawals” from the data bank account by exporting copies of their data elsewhere for their own use.

Data Marketplace

The computer architecture, computer-implemented instructions, IPOs, GUIs, databases and file management may provide a data marketplace configured to connect individuals with control over their personal data to businesses seeking to buy personal data. The data marketplace may be configured to facilitate transactions if both parties agree to the terms of sale. The data marketplace may be configured to provide liquidity for a customer's personal data. The data marketplace may be configured to allow businesses to submit bids for one or more portions of an individual's personal data along with an explanation of how the data will be used. The data marketplace may be configured to prompt qualifying individuals to agree to (or deny) terms of a transaction. The terms may include an assurance that the data will not be used for any other purpose or re-sold to a third party.

Virtual Snapshot

The computer architecture, computer-implemented instructions, IPOs, GUIs, databases and file management may be configured to provide customers with a virtual snapshot. The virtual snapshot may be configured to allow a customer to view how their movements and behaviors are being tracked and recorded. The tracking and recording may include selected portions of time or every moment of time in a given timeframe. The virtual snapshot may be configured to allow customers to view their location data for any given day or time. The virtual snapshot may be configured to allow customers to view their behaviors at one or more locations.

Psychometric Analysis

The computer architecture, computer-implemented instructions, IPOs, GUIs, databases and file management may be configured to show customers how their personality can be predicted with significant accuracy. Personality predictions may be provided using only the customer's social media data. Customers may be prompted to fill out a personality quiz. Customers may be prompted to compare an accuracy of the social media predictions with results of the personality quiz. Individuals have previously been unable to see the process and accuracy of psychometric predictions using personal data.

Data Valuation

The computer architecture, computer-implemented instructions, IPOs, GUIs, databases and file management provide customers with a list of companies that have bought their data. The computer architecture, computer-implemented instructions, IPOs, GUIs, databases and file management provide an estimate of a total value their data has created for other companies. The computer architecture, computer-implemented instructions, IPOs, GUIs, databases and file management may be configured to provide information to customers that help the customers become more aware of the value of their data. A customer that is made more aware of the value of their data may become less susceptible to targeted advertisements from companies who have purchased their data.

Details of non-limiting exemplary embodiments of the computer architecture, computer-implemented instructions, IPOs, GUIs, databases and file management are provided hereinbelow. One or more features of each of the exemplary embodiments may be combined in any suitable combination without limitation.

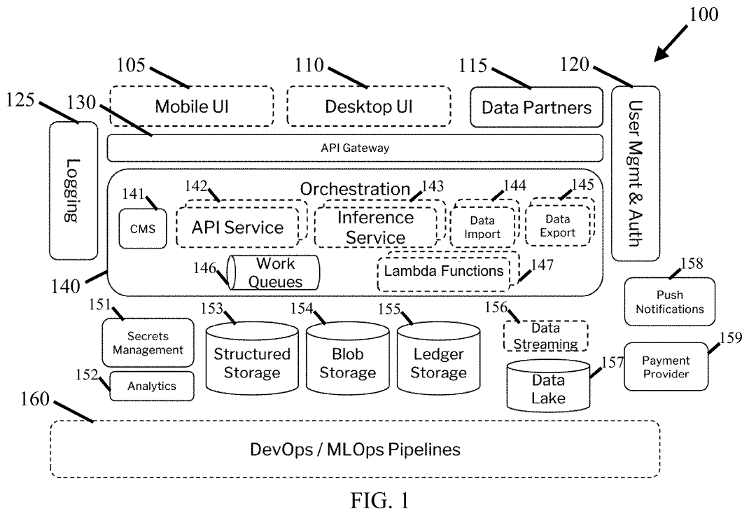

FIG. 1 is a diagram of an exemplary architecture 100 for a system, according to some implementations of the current subject matter. The architecture 100 may be configured to promote one or more capabilities including productionization, limitation of technical debt, preservation of assets, friction free operation, rapid ability to change, desktop and mobile delivery, business to business integration, development of customer insights, and proof of offering.

The architecture 100 may be a microservice. The microservice may separate functionality into independently deployable services with low coupling and high cohesion. The architecture 100 may be cloud centric. The architecture 100 may leverage capabilities of cloud providers to reduce custom code and reduce maintenance overhead. The architecture 100 may be configured to deliver continuous integration, continuous delivery and/or continuous deployment (CI/CD). The architecture 100 may be configured to automate recurring activities so developers can focus on developing new functionality. The architecture 100 may be secure. The architecture 100 may be configured to provide security appropriate to data handled to protect customers' private information including PII.

The architecture 100 may include one or more of the following: a mobile user interface (UI) module 105, a desktop UI module 110, a data partners module 115, a user management and authorization module 120, a logging module 125, and an application programming interface (API) gateway module 130. The architecture 100 may include an orchestration layer 140. The orchestration layer 140 may include one or more of the following: a content management system (CMS) 141, an API service module 142, an inference service module 143, a data import module 144, a data export module 145, a work queues module 146, and a lambda functions module 147. The architecture 100 may include one or more of the following: a secrets management module 151, an analytics module 152, a structured storage module 153, a blob storage module 154, a ledger storage module 155, a data streaming module 156, a data lake module 157, a push notifications module 158, and a payment provider module 159. The architecture 100 may include one or more pipelines 160 including one or more of the following: software development (Dev) pipelines, IT operations (Ops) pipelines, and machine learning operations (MLOps or MLDevOps). One or more of the above-referenced modules, layers, systems, and pipelines may be integrated or separately provided. One or more of the modules 105, 110, 142-145, 147, and 156, inclusive, and the one or more pipelines 160 may be omitted or duplicated.

The architecture 100 may be configured for security, storage, and orchestration. The architecture 100 may be configured to provide one or more of identity and access management (IAM), encryption at rest, and encryption in flight. The architecture 100 may be configured to identify, authenticate, and guard access to system resources. One or more of the structured storage module 153, the blob storage module 154, the ledger storage module 155, and the data lake module 157 may be configured to minimize storage cost over a lifetime of the system. The orchestration layer 140 may be configured to deploy, invoke, and manage deployable units of code across the architecture 100.

The IAM may be configured to authenticate users into the architecture 100, provide roles the user may play, provide the user with account self-service features, and store account metadata. In some exemplary embodiments, the IAM may be Amazon Web Services (AWS) Cognito to provide clean integration with other AWS components, to reduce initial development time, to support phone-only authorization (auth), to support federated auth to one or more third parties as an option for web login, and to ensure system and organization controls (SOC) and Payment Card Industry (PCI) compliance.

The encryption at rest may be configured to protect all data when stored in a web services facility and to provide protection transparent to the application logic. The encryption at rest may be AWS Key Management System to ensure a clean integration with other AWS components and to reduce initial development time.

The architecture 100 is not limited to AWS and may include any suitable web services platform including Alibaba Cloud, CloudSigma, Dell Cloud, DigitalOcean, Google Cloud Platform, IBM Cloud, Kamerata, LimeStone, Linode, LiquidWeb, MassiveGrid, Microsoft Azure, NaviSite, NetApp Cloud, Open Nebula, Oracle Cloud, Pivotal, Quadranet, Rackspace, Verizon Cloud, VMware, one or more generic physical servers, and the like.

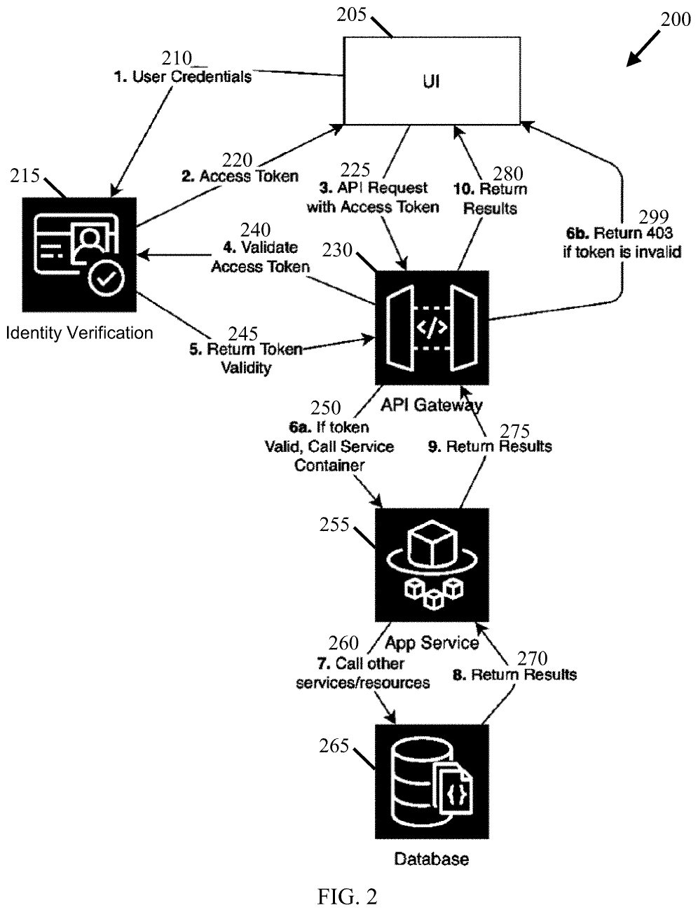

FIG. 2 is a diagram of an exemplary sign in flow 200, according to some implementations of the current subject matter. The sign in flow 200 may include a user interface (UI) module 205 connected directly or indirectly to one or more of an identity verification module 215 (such as Cognito), an API gateway 230, an application (app) service 255, and one or more databases 265. The UI module 205 may be the mobile UI 105, the desktop UI 110, or a separate module. The identity verification module 215 may be part of the user management and authentication module 120, or a separate module. The API gateway 230 may be the API gateway 130, or a separate module. The app service 255 may be a data partner connected via the data partners module 115, or a separate module. The one or more databases 265 may be a data partner connected via the data partners module 115, the structured storage 153, the blob storage 154, the ledger storage 155, the data lake 157, an external database, or a separate module.

The sign in flow 200 may include one or more operations. The sign in flow 200 may include the UI module 205 prompting a user for user credentials and providing the user credentials to the identity verification module 215 (at 210). The sign in flow 200 may include the identity verification module 215 determining whether the user credentials are valid. The sign in flow 200 may include, based on a determination that the user credentials are valid, the identity verification module 215 returning an access token (e.g., a JavaScript Object Notation (JSON) Web Token (JWT)) to the UI module 205 (at 220). The sign in flow 200 may include the UI module 205 sending a request including the access token to the API gateway 230 (at 225). The sign in flow 200 may include the API gateway 230 validating the access token. An initial validation may require a call to the identity verification module 215 (at 240). Subsequent validations may be performed in the API gateway 230 and may not require the call to the identity verification module 215. The sign in flow 200 may include the identity verification module 215 returning the validated access token to the API gateway 230 (at 245). The sign in flow 200 may include, based on a determination that the access token is valid, the API gateway 230 forwarding a request to the app service 255 (at 250). The app service 255 may use contents of the validated access token to determine a username and roles for the user. The sign in flow 200 may include the app service 255 calling one or more other services or resources on behalf of the validated user (at 260). The other services or resources may include the one or more databases 265. The sign in flow 200 may include the one or more databases 265 returning results to the app service 255 (at 270). The sign in flow 200 may include the app service 255 returning results to the API gateway 230 (at 275). The sign in flow 200 may include the API gateway 230 returning results to the UI module 205 (at 280). The sign in flow 200 may include, based on a determination that the access token is invalid, the API gateway 230 returning an error code (e.g., 403) to the UI module 205 (at 299).

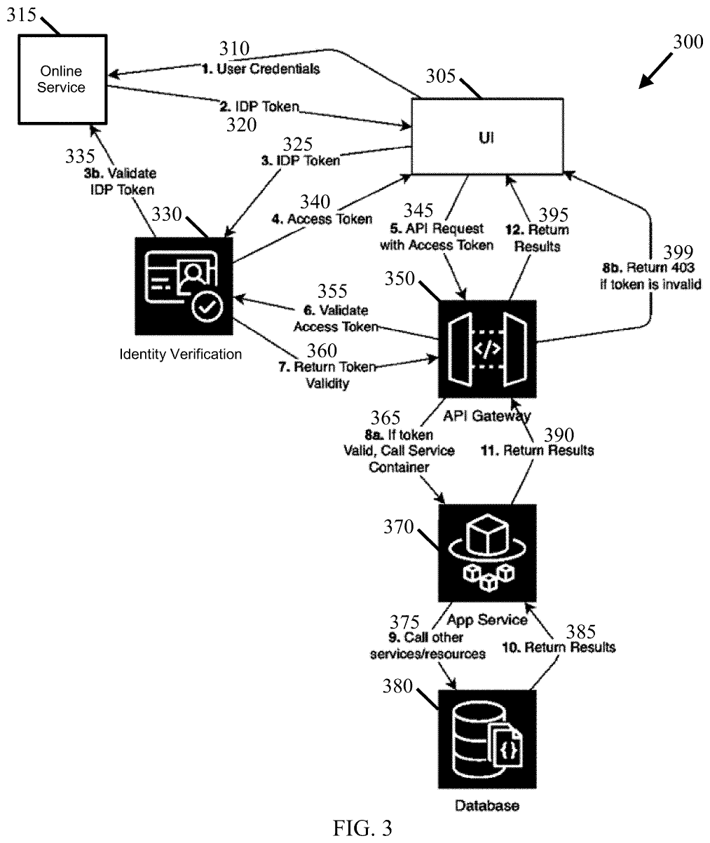

FIG. 3 is a diagram of an exemplary federated sign in flow 300, according to some implementations of the current subject matter. The federated sign in flow 300 may include a user interface (UI) module 305 connected directly or indirectly to one or more of an online service 315 (such as Google), an identity verification module 330 (such as Cognito), an API gateway 350, an application (app) service 370, and one or more databases 380. The UI module 305 may be the mobile UI 105, the desktop UI 110, the UI module 205, or a separate module. The online service 315 may be a data partner connected via the data partners module 115, or a separate module. The identity verification module 330 may be part of the user management and authentication module 120, or a separate module. The API gateway 350 may be the API gateway 130, the API gateway 230, or a separate module. The app service 370 may be a data partner connected via the data partners module 115, the app service 255, or a separate module. The one or more databases 380 may be a data partner connected via the data partners module 115, the structured storage 153, the blob storage 154, the ledger storage 155, the data lake 157, the one or more databases 265, an external database, or a separate module.

The federated sign in flow 300 may include one or more operations. The federated sign in flow 300 may include the UI module 305 prompting a user for user credentials or obtaining previously obtained user credentials (e.g., at 210) and providing the user credentials to the online service 315 (at 310). The federated sign in flow 300 may include the online service 315 determining whether the user credentials are valid. The federated sign in flow 300 may include, based on a determination that the user credentials are valid, the online service 315 returning an identity provider (IDP) access token to the UI module 305 (at 320). The federated sign in flow 300 may include the UI module 305 providing the IDP token to the identity verification module 330 (at 325). The federated sign in flow 300 may include the identity verification module 330 determining whether the user credentials are valid. The federated sign in flow 300 may include, based on a determination that the user credentials are valid, the identity verification module 330 returning a JWT access token to the UI module 305 (at 340). The federated sign in flow 300 may include the UI module 305 sending a request including the JWT access token to the API gateway 350 (at 345). The federated sign in flow 300 may include the API gateway 350 validating the access token. An initial validation may require a call to the identity verification module 330 (at 355). Subsequent validations may be performed in the API gateway 350 and may not require the call to the identity verification module 330. The federated sign in flow 300 may include the identity verification module 330 returning the validated access token to the API gateway 350 (at 360). The federated sign in flow 300 may include, based on a determination that the access token is valid, the API gateway 350 forwarding a call or a request to the app service 370 (at 365). The app service 370 may use contents of the validated access token to determine a username and roles for the user. The federated sign in flow 300 may include the app service 370 calling one or more other services or resources on behalf of the validated user (at 375). The other services or resources may include the one or more databases 380. The federated sign in flow 300 may include the one or more databases 380 returning results to the app service 370 (at 385). The federated sign in flow 300 may include the app service 370 returning results to the API gateway 350 (at 390). The federated sign in flow 300 may include the API gateway 350 returning results to the UI module 305 (at 395). The federated sign in flow 300 may include, based on a determination that the access token is invalid, the API gateway 350 returning an error code (e.g., 403) to the UI module 305 (at 399).

In general, storage may involve one or more of unstructured data, immutable data, and structured data. The unstructured data may be data without a predefined and/or consistent data format, e.g., zip files from takeout services, e.g., Google Takeout, which permits a user to export data to a downloadable archive file. In some exemplary embodiments, S3 and Athena may be used for extraction and analysis. The immutable data may be ledger data to record transactions and activity in a format that is impractical to modify. The ledger data may be stored in any suitable database including the ledger storage module 155. In some exemplary embodiments, Quantum Ledger Database (QLDB) may be utilized. The structured data may be data structured into rows or columns with fields, attributes, and indexes. The structured data model 400 may be used with any database including the structured storage module 153.

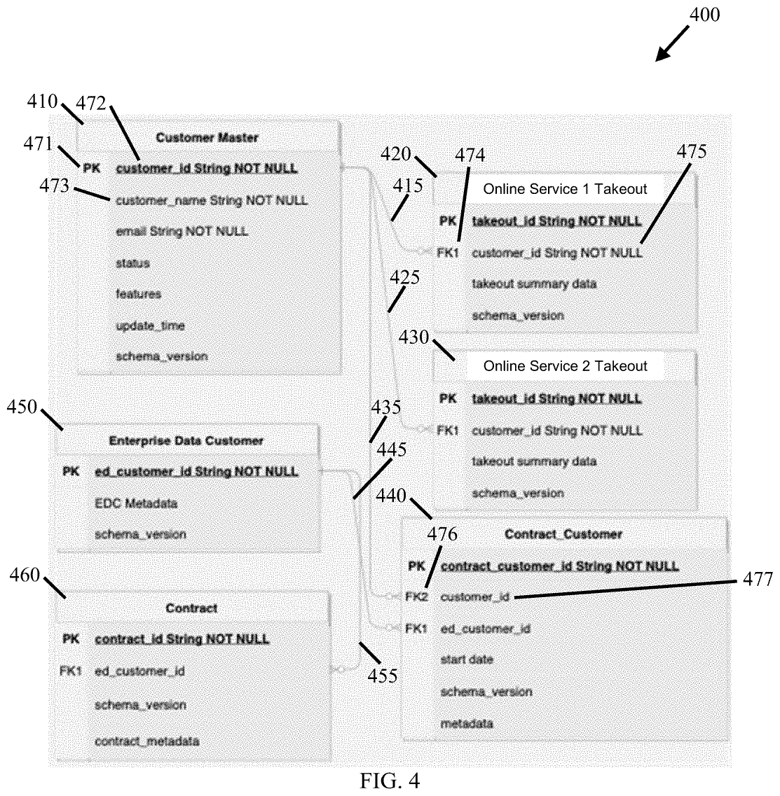

FIG. 4 is a diagram of an exemplary structured data model 400, according to some implementations of the current subject matter. The structured data model 400 may be configured to store customer meta data. The structured data model 400 may be configured to store aggregation of customer information. The structured data model 400 may be configured to track a state of activity at any point within the architecture 100. In some exemplary embodiments, DocumentDB may be utilized to provide relatively flexible access patterns and document structure, may be similar to Firebase DB in data structure, may provide relatively more control regarding structure, indexing, and reliability, may be compatible with an industry standard such as MongoDB, and may be SOC and PCI compliant. Also, DocumentDB may provide flexibility for growth. Alternatively, Cassandra may be utilized in lieu of DocumentDB.

The structured data model 400 may be a unitary data structure. The unitary data structure may be configured for one or more data process operations including: analysis, cleansing, collection, compression, corruption/decorruption, curation, defragmentation, degradation/gradation, editing, extract load transform (ELT), extract transform load (ETL), farming, format management, fusion, integration, integrity, library, loss/recovery, management, migration, mining, pre-processing, preservation, protection (privacy), recovery, reduction, retention, quality, scraping, scrubbing, security, stewardship, storage, validation, warehouse, and wrangling/munging.

The structured data model 400 may be configured for relatively loose coupling, relatively high cohesion, and without multi-collection operational access. With the loose coupling, collections relating to third party sources may be kept separate from other internal and third party sources. Also, with the loose coupling, data lake structures may not mirror operational data structures. With the high cohesion, data closely related to each other may be kept in the same collection. Also, the high cohesion may be balanced with the loose coupling. Further, the loose coupling may be given a higher priority. With the lack of multi-collection operational access, operational services may not access more than one collection directly. Also, with the lack of multi-collection operational access, the data required from other collections may use API access.

In some exemplary embodiments, the structured data model 400 may include one or more of a customer master database 410, a first online service takeout database 420, a second online service takeout database 430, a contract customer database 440, an enterprise data customer database 450, and a contract database 460. The customer master database 410 may have a one-to-many relationship 415 with the first online service takeout database 420. The customer master database 410 may have a one-to-many relationship 425 with the second online service takeout database 430. The customer master database 410 may have a one-to-many relationship 435 with the contract customer database 440. The enterprise data customer database 450 may have a one-to-many relationship 445 with the contract customer database 440. The enterprise data customer database 450 may have a one-to-many relationship 455 with the contract database 460. One or more of the customer master database 410, the first online service takeout database 420, the second online service takeout database 430, the contract customer database 440, the enterprise data customer database 450, and the contract database 460 may have one or more of each of a primary key indicator field 471 (e.g., PK in the customer master database 410), a primary key field 472 (e.g., customer_id String NOT NULL in the customer master database 410), an unencrypted field 473 (e.g. customer_name String NOT NULL in the customer master database 410), a first foreign key indicator field 474 (e.g., FK1 in the first online service takeout database 420), a first foreign key field 475 (e.g., customer_id String NOT NULL in the first online service takeout database 420), a second foreign key indicator field 476 (e.g., FK2 in the contract customer database 440), and a second foreign key field 477 (e.g., customer_id in the contract customer database 440). Each of the first online service takeout database 420 or the second online service takeout database 430 may be configured to store data from one or more of Google, Instagram, and the like.

The orchestration layer 140 may be configured to manage running code. The orchestration layer 140 may be configured to auto scale resources as load requires. The orchestration layer 140 may be configured to detect and repair faults. The orchestration layer 140 may be configured to manage resources allocated to code. The orchestration layer 140 may be configured to facilitate inter-service communications. In some exemplary embodiments, the orchestration layer 140 may include Amazon Elastic Container Service (ECS). ECS may be relatively easier to ramp up than Amazon EKS/Kubernetes, may provide consistent response times compared to serverless, may provide a relatively straightforward transition to another orchestration platform, if necessary, and may have a lower cost than EKS.

The orchestration layer 140 may be configured to process relatively long running transactions including takeout loads, inference processing (e.g., via inference service module 143), and data exports (e.g., via data export module 145). In some exemplary embodiments, the orchestration layer 140 may include lambda step functions (e.g., via lambda functions module 147), which may be AWS Step Functions. AWS Step Functions may be suited for relatively bursty loads associated with the architecture 100, may have a lower cost since code is not running constantly, may use the same language as an existing system, and may result in a user experience that is not impacted by cold-starts.

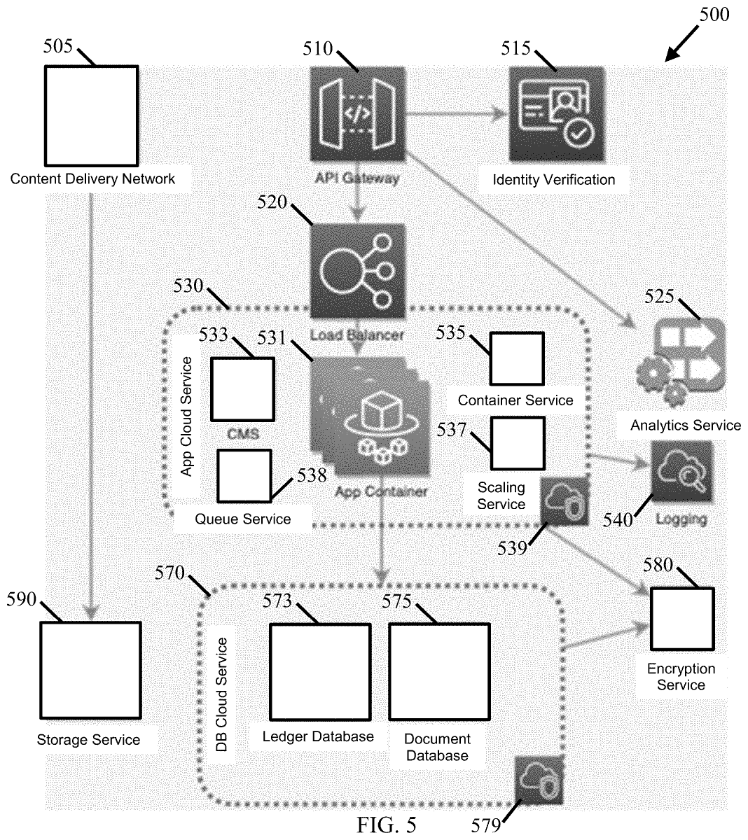

FIG. 5 is a diagram of an exemplary user data access flow 500, according to some implementations of the current subject matter. The user data access flow 500 may be configured for direct interaction from mobile and web interfaces. The user data access flow 500 may be configured for interactive access and submission of data from the user. The user data access flow 500 may be configured for relatively low response times, which are critical to the direct interactions. The user data access flow 500 may be configured to deliver questionnaires to users. The user data access flow 500 may be configured to efficiently execute transactions.

The user data access flow 500 may include a content delivery network 505 (e.g., CloudFront) connected directly or indirectly to a storage service 590 (e.g., S3). The user data access flow 500 may include an API gateway 510 connected directly or indirectly to one or more of an identity verification module 515 (e.g., Cognito), a load balancer 520, an analytics service module 525 (e.g., MixPanel), an application cloud service 530 (e.g., Amazon Virtual Private Cloud (VPC)), a logging module 540 (e.g., Amazon CloudWatch), a database cloud service 570 (e.g., Amazon DB VPC), and an encryption service 580 (e.g., Amazon Secrets Manager). The application cloud service 530 may include one or more application containers 531. The application cloud service 530 may include one or more of a content management system (CMS) module 533 (e.g., Amazon Cloud CMS), a container service 535 (e.g., ECS), a scaling service 537 (e.g., Amazon EC2 Auto Scaling), and a queue service 538 (e.g., Amazon Simple Queue Service (SQS)). The database cloud service 570 may include a ledger database module 573 (e.g., QLDB) and a document database 575 (e.g., DocumentDB). Each of the application cloud service 530 and the database cloud service 570 may include a Distributed Denial of Service (DDoS) attack protection module 539, 579, respectively (e.g., AWS Shield).

The user data access flow 500 may be configured to pull web content (e.g., CSS, HTML, JS) from the storage service 590 via the content delivery network 505. The user data access flow 500 may be configured to receive a request for content or data from a UI platform (mobile or web), e.g., via the mobile UI module 105 and/or the desktop UI module 110. The API gateway 510 may be configured to validate the JWT token attached to the request. The API gateway 510 may be configured to validate a structure and a rate of request. The API gateway 510 may be configured to forward the request to the load balancer 520. The load balancer 520 may forward the request to a healthy operational application container 531 appropriate for a type of the request. The container service 535 and the scaling service 537 may ensure sufficient containers are running. The application container 531 may make one or more requests to one or more databases for data. The mobile UI module 105 and/or the desktop UI module 110 may log events to the analytics service 525. The application container 531 may log debug logs to the logging module 540. The database cloud service 570 may retrieve secrets from the encryption service 580.

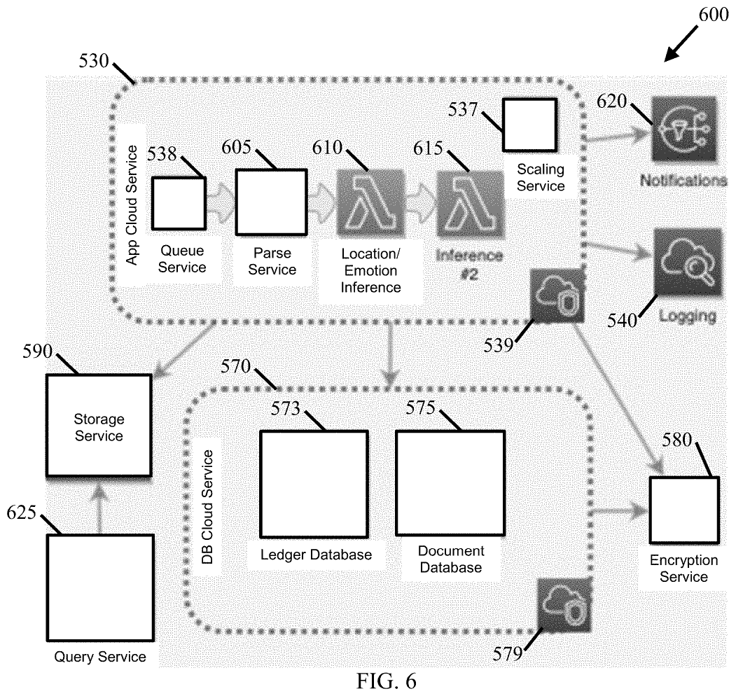

FIG. 6 is a diagram of an exemplary process takeout file flow 600, according to some implementations of the current subject matter. The process takeout file flow 600 may be configured to perform relatively longer running tasks detached from user sessions. The process takeout file flow 600 may be configured to process data from takeouts and other third party sources. The process takeout file flow 600 may be configured to prepare data for export to partners.

The process takeout file flow 600 may include one or more of the features of the user data access flow 500 whose descriptions may be considered the same as those detailed above unless noted otherwise and are omitted for brevity. In addition, the process takeout file flow 600 may include the application cloud service 530 and the database cloud service 570. The application cloud service 530 may further include a parse service 605 (e.g., Google Parse), a location and/or emotion inference module 610, and a second inference module 615. The queue service 538, the parse service 605, the location and/or emotion inference module 610, and the second inference module 615 may operate in series. The application cloud service 530 may be connected directly or indirectly to a notifications module 620. A query service 625 (e.g., Athena) may be connected directly or indirectly to the storage service 590.

The process takeout file flow 600 may be triggered by an external event. The external event may be a queue entry from the queue service 538, an API call from the API gateway 510, or a timer. The process takeout file flow 600 may include one or more lambda functions. Lambda functions permit isolation of code and facilitates reuse of certain code in different flows. The parse service 605 may include a first lambda function, which performs processing. The parse service 605 may leave artifacts in one or more of the storage service 590, the ledger database 573, and the document database 575. The parse service 605 may pass to a next step. The next step may include specialized processing including one or more of the location and/or emotion inference module 610, and the second inference module 615. Notifications may be sent by the notifications module 620 to the UIs (e.g., mobile UI module 105, desktop UI module 110, and the like) or partners (e.g., data partners module 115), as appropriate for the operation. Debugging, logging and secrets may be processed as noted above. The artifacts in the storage service 590 may be later read by the query service 625 for export.

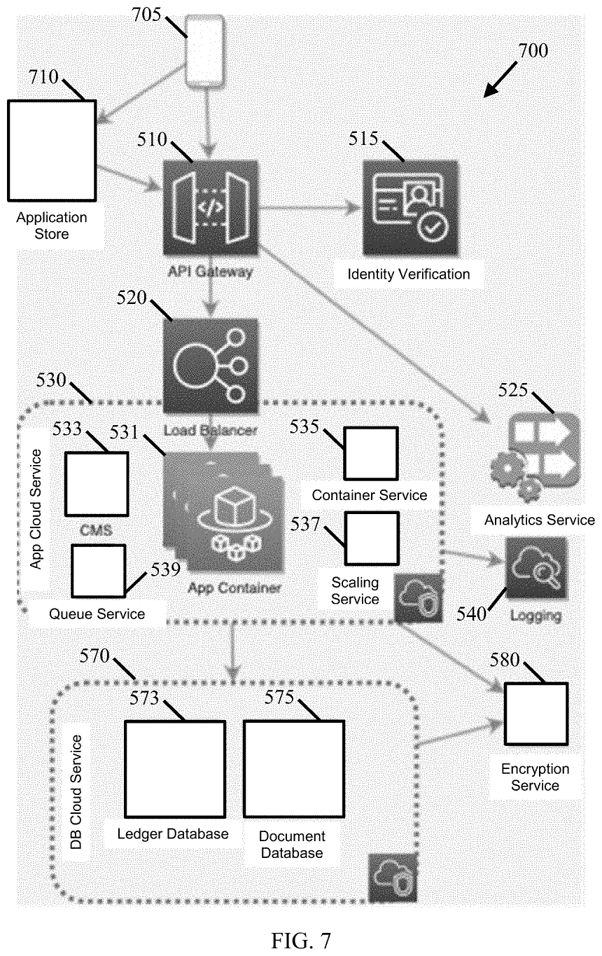

FIG. 7 is a diagram of an exemplary subscribe to professional (pro) version flow 700, according to some implementations of the current subject matter. The subscribe to pro version flow 700 may be configured to interact with mobile platforms for subscriptions.

The subscribe to pro version flow 700 may include one or more of the features of the user data access flow 500 whose descriptions may be considered the same as those detailed above unless noted otherwise and are omitted for brevity. In addition, the subscribe to pro version flow 700 may include a user device 705 (e.g., a cell phone, such as an Apple iPhone), which may be connected to an application store 710 (e.g., Apple App Store, or the like), which may be connected to the API gateway 510.

The subscribe to pro version flow 700 may be configured to presents subscription options to a user. The user may be prompted to go through a purchase process on the user device 705 with the application store 710. The application store 710 may provide a signed receipt to the user device 705. The application store 710 may provide a receipt to the architecture 100. The subscribe to pro version flow 700 may record the upgrade purchase. The upgrade may be provided to other user devices (not shown) used by the same user.

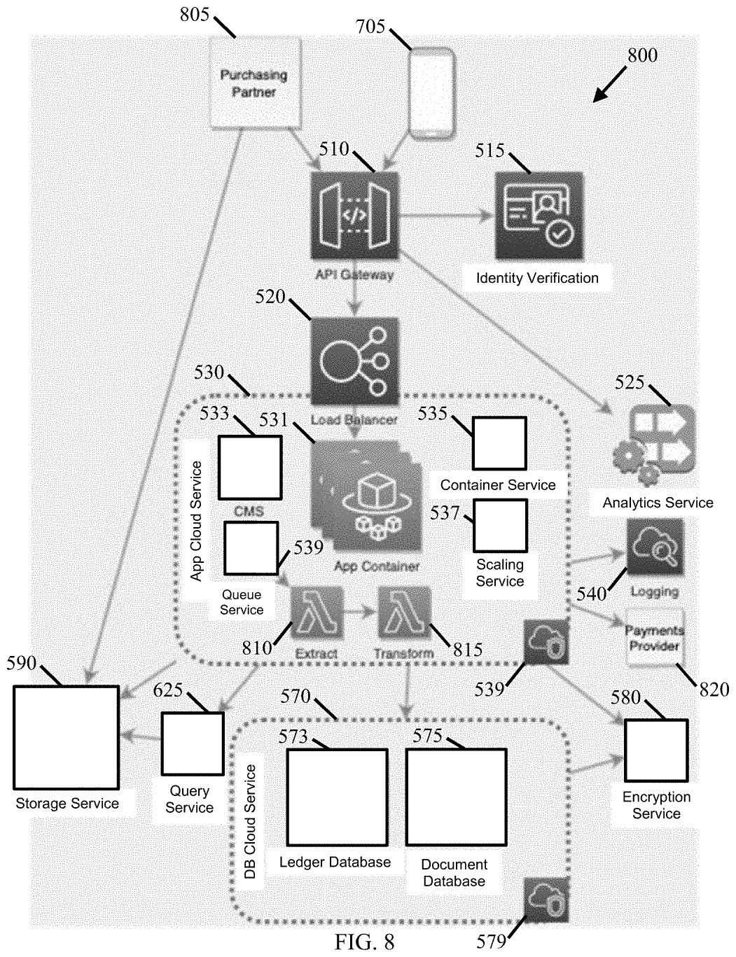

FIG. 8 is a diagram of an exemplary customer sells data to partner flow 800, according to some implementations of the current subject matter. The customer sells data to partner flow 800 may be configured to record acceptance of a sale of one or more portions of data to a purchasing partner 805. The customer sells data to partner flow 800 may be configured to generate a data load for the purchasing partner 805.

The customer sells data to partner flow 800 may include one or more of the features of the user data access flow 500, the process takeout file flow 600, and the subscribe to pro version flow 700, whose descriptions may be considered the same as those detailed above unless noted otherwise and are omitted for brevity. In addition, the application cloud service 530 may include an extract lambda function module 810 and a transform lambda function module 815. The application cloud service 530 may be connected directly or indirectly to a payments provider 820.

The customer sells data to partner flow 800 may be configured to present a customer with an offer for data. The customer sells data to partner flow 800 may be configured to prompt the customer to accept the offer and provide remittance information. The customer sells data to partner flow 800 may be configured to record the offer in the ledger database 573 and the document database 575. The purchasing partner 805 may request data. The extract lambda function module 810 and the transform lambda function module 815 may respectively extract and transform data into a format required by the purchasing partner 805. The extracted data may be stored in the storage service 590. A notification may be sent (e.g., via the notifications module 620) to the purchasing partner 805. The notification may indicate that the extracted data is ready. The purchasing partner 805 may request an extract URL, which is a short-lived URL for the data. The purchasing partner 805 may be permitted to download the data from the storage service 590. Remittance to the customer may be requested via the payments provider module 820. The storage service 590 may delete the downloaded files after a specified period of time.

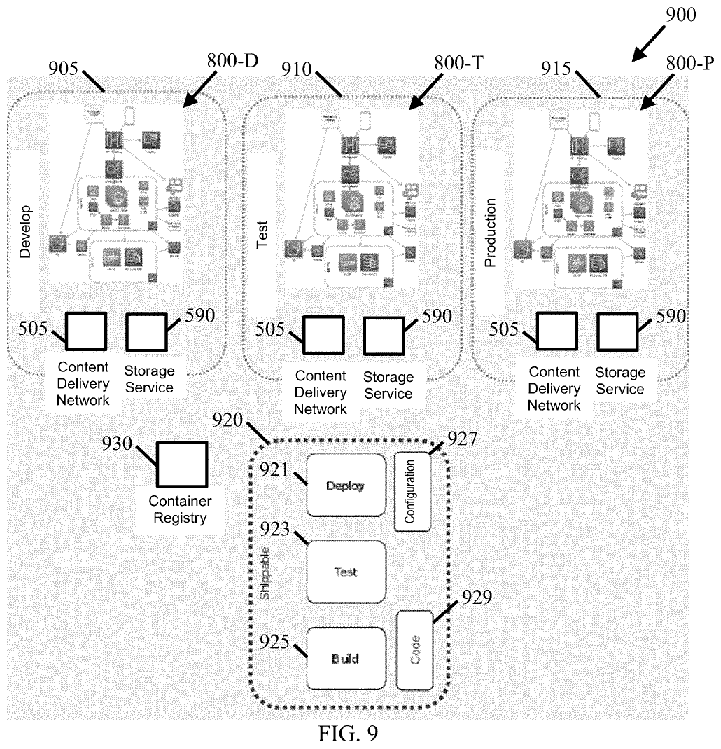

FIG. 9 is a diagram of an exemplary develop, test and deploy flow 900, according to some implementations of the current subject matter. The develop, test and deploy flow 900 may be configured to provide continuous delivery of software as updates are validated. The develop, test and deploy flow 900 may be configured to reduce manual intervention in system operation.

The develop, test and deploy flow 900 may include one or more of the features of the user data access flow 500, the process takeout file flow 600, the subscribe to pro version flow 700, and the customer sells data to partner flow 800 whose descriptions may be considered the same as those detailed above unless noted otherwise and are omitted for brevity. In the exemplary embodiment of FIG. 9, three versions of the customer sells data to partner flow 800 are depicted including a develop version 800-D of the customer sells data to partner flow 800, a test version 800-T of the customer sells data to partner flow 800, and a production version 800-P of the customer sells data to partner flow 800. In addition, the develop, test and deploy flow 900 may connected directly or indirectly to a CI/CD and DevOps automation platform 920 (e.g., Shippable). CI/CD and DevOps automation platform 920 may include a deploy module 921, a test module 923, a build module 925, a configuration module 927, and a code module 929. Also, the develop, test and deploy flow 900 may be connected directly or indirectly to a container registry 930 (e.g., Amazon Elastic Container Registry (ECR)).

The develop, test and deploy flow 900 may be configured to permit a developer to write and unit test code 929 locally on a workstation, e.g., write the develop version 800-D via the build module 925. The develop, test and deploy flow 900 may be configured to permit the developer to commit the code 929 and submit a request to merge the code 929 into a branch. The develop, test and deploy flow 900 may be configured to accept the merge. The develop, test and deploy flow 900 may be configured to automatically test the code 929, e.g., the test version 800-T via the test module 923. The develop, test and deploy flow 900 may be configured, based on the code 929 passing the test, to deploy the code 929 into development, e.g., the production version 800-P via the deploy module 921. The develop, test and deploy flow 900 may be configured to direct a future merge request into an upstream branch, which triggers the deployment of the code 929 into upstream environments.

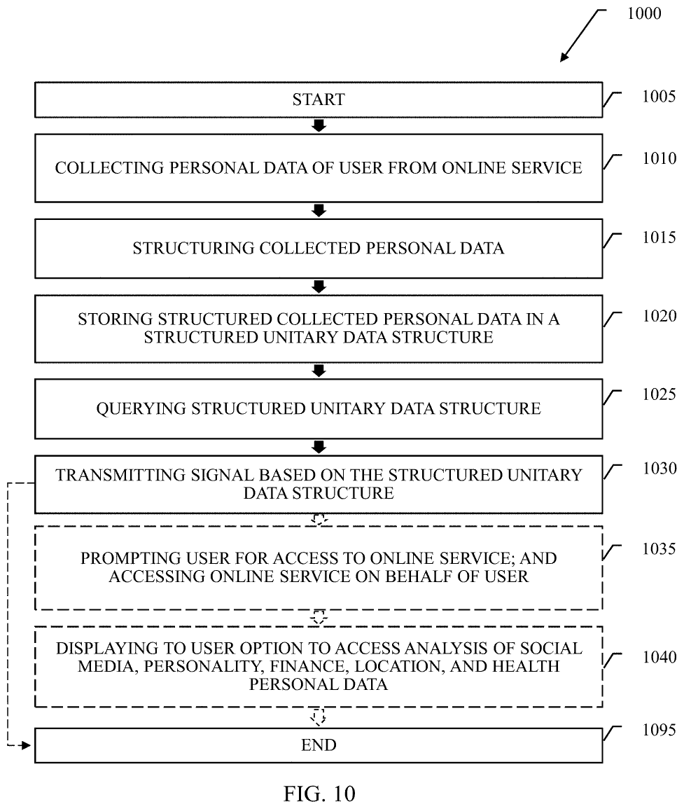

FIG. 10 is a flow chart of an exemplary method 1000 for collecting, structuring, and storing personal data of a user of an online service, according to some implementations of the current subject matter. The method 1000 may include a start 1005 and an end 1095. The method 1000 may include collecting the personal data of the user from the online service (at 1010). The method 1000 may include structuring the collected personal data (at 1015). The method 1000 may include storing the structured collected personal data in a structured unitary data structure (at 1020). The structured unitary data structure may be configured to store at least one of the following: customer data, search engine data, social media data, contract customer data, enterprise customer data, and contract data. The method 1000 may include querying the structured unitary data structure (at 1025). The method 1000 may include transmitting a signal based on the query (at 1030). The method 1000 may proceed directly to the end, at 1095. The method 1000 may optionally include additional operations. The method 1000 may include transmitting prompting the user for access to the online service; and accessing the online service on behalf of the user (at 1035). The method 1000 may include displaying to the user an option to access analysis of social media, personality, finance, location, and health personal data (at 1040). Any of the above-referenced operations may be performed in any suitable order.

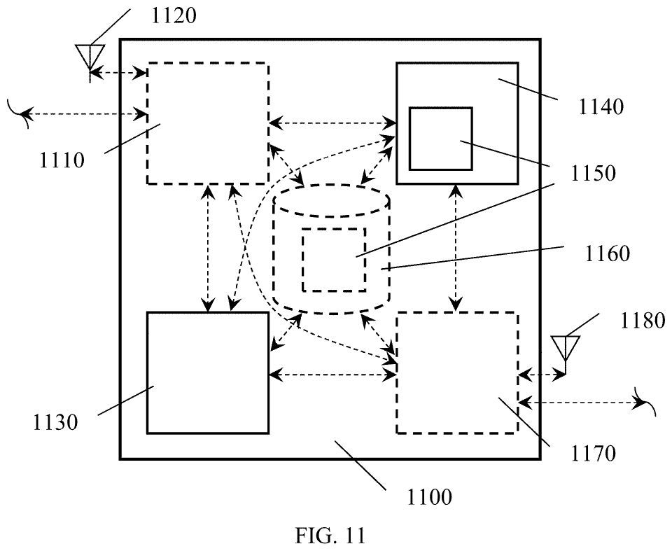

FIG. 11 is a schematic diagram of an exemplary computer device or system including at least one processor and a memory storing at least one program for execution by the at least one processor, according to some implementations of the current subject matter. Specifically, FIG. 11 depicts a computer device or system 1100 including at least one processor 1130 and a memory 1140 storing at least one program 1150 for execution by the at least one processor 1130. In some embodiments, the device or computer system 1100 can further include a non-transitory computer-readable storage medium 1160 storing the at least one program 1150 for execution by the at least one processor 1130 of the device or computer system 1100. In some embodiments, the device or computer system 1100 can further comprise at least one input device 1110, which can be configured to send or receive information to or from any one from the group consisting of: an external device (not shown), the at least one processor 1130, the memory 1140, the non-transitory computer-readable storage medium (CRM) 1160, and at least one output device 1170. The at least one input device 1110 can be configured to wirelessly send or receive information to or from the external device via a means for wireless communication, such as an antenna 1120, a transceiver (not shown) or the like. In some embodiments, the device or computer system 1100 can further comprise at least one output device 1170, which can be configured to send or receive information to or from any one from the group consisting of: an external device (not shown), the at least one input device 1110, the at least one processor 1130, the memory 1140, and the non-transitory computer-readable storage medium 1160. The at least one output device 1170 can be configured to wirelessly send or receive information to or from the external device via a means for wireless communication, such as an antenna 1180, a transceiver (not shown) or the like.

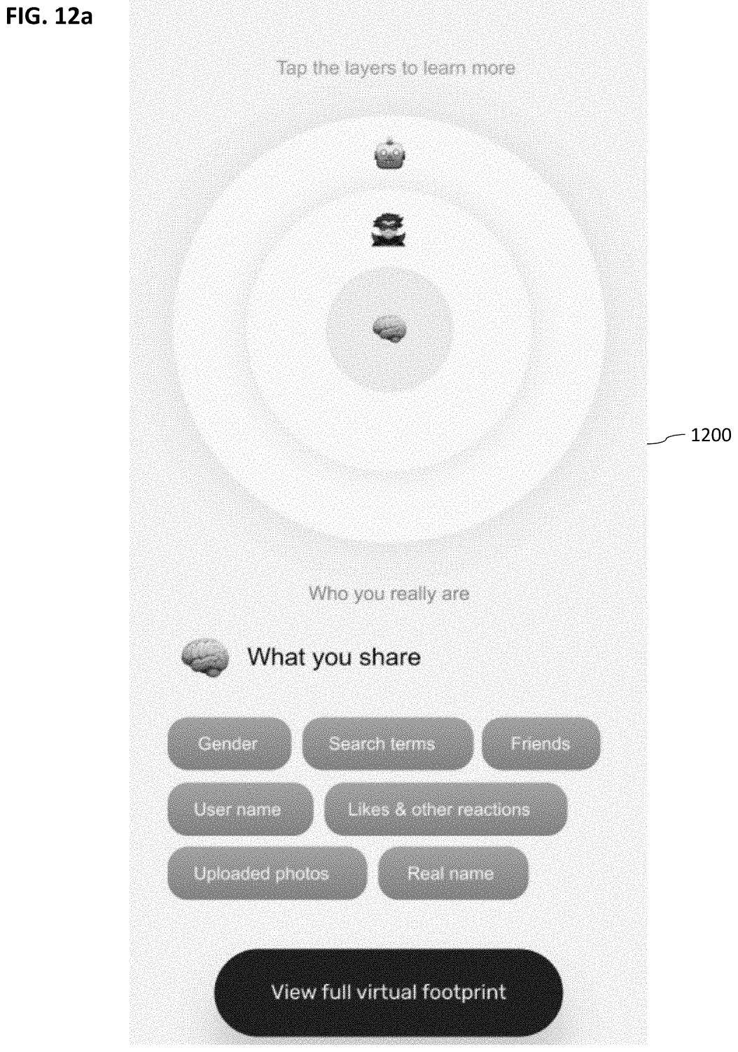

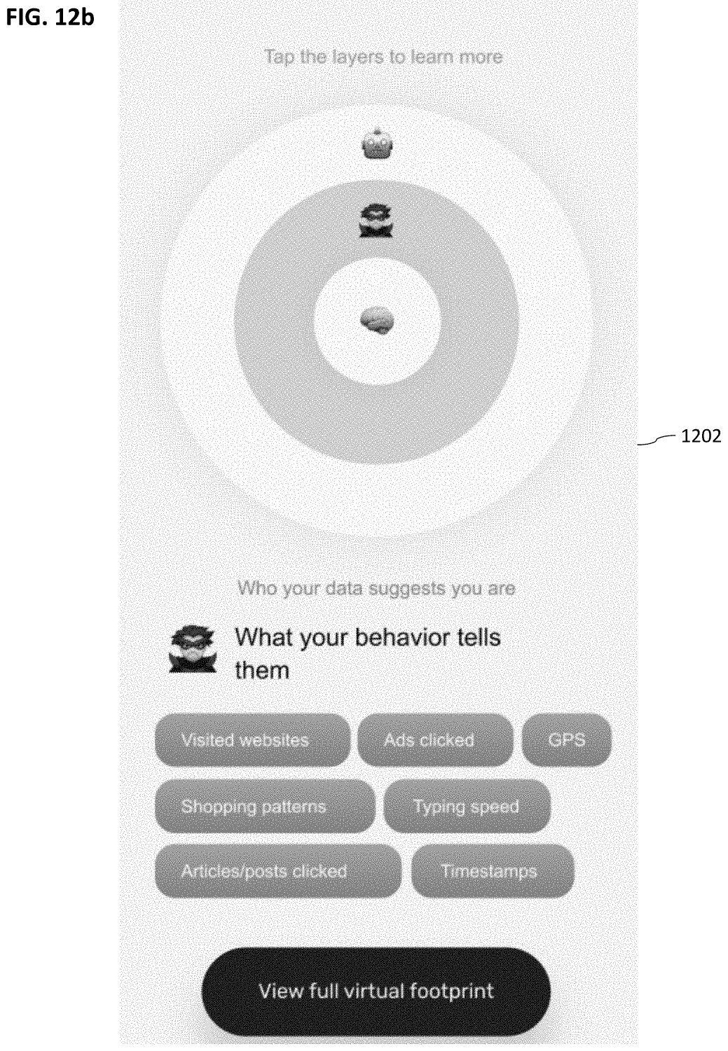

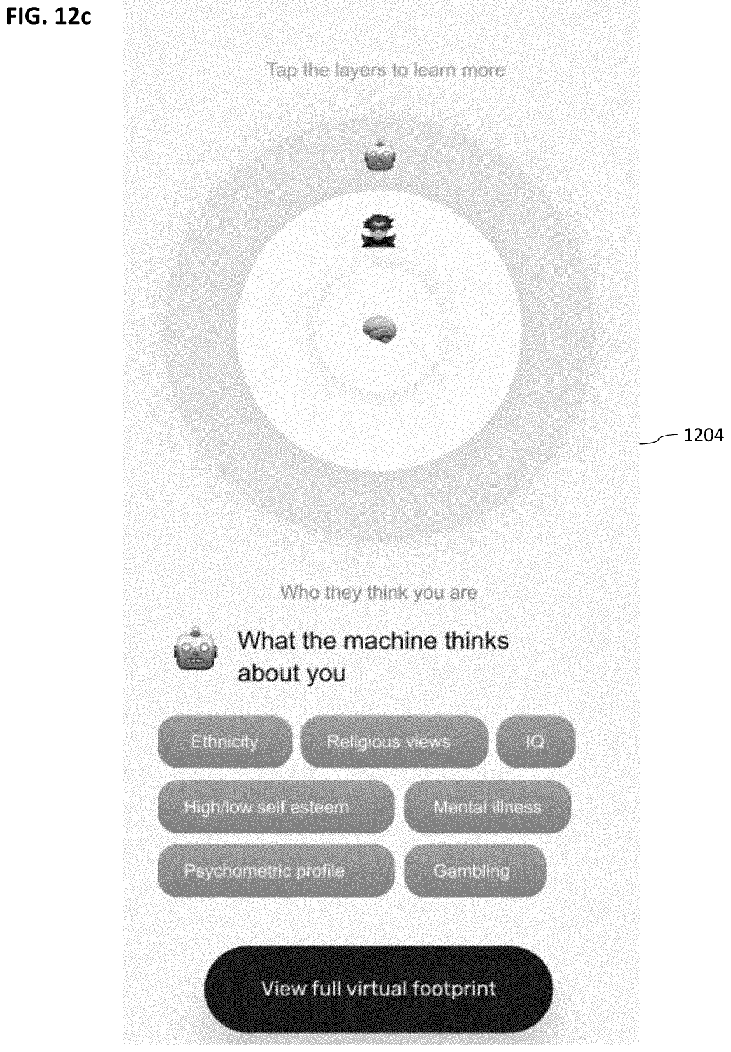

FIGS. 12A to 33, inclusive, depict a plurality of exemplary GUIs that may be generated by the above-referenced method, system and CRM, according to some exemplary implementations. The plurality of GUIs of FIGS. 12a to 33 may be displayed on any suitable display. The GUIs may be displayed via, for example, the mobile UI module 105, the desktop UI module 110, the UI module 205, the UI module 305, the user device 705, the at least one output device 1170, or the like, either alone or in combination. Any one of the plurality of GUIs of FIGS. 12a to 33 (and/or any other GUIs) may include one or more links to one or more other of the plurality of GUIs of FIGS. 12a-33. The GUIs and links described below are exemplary and may be modified and rearranged to achieve at least the above-referenced functions and purposes of the method, system and CRM, and all equivalent functions and purposes thereof.

The text strings or prompts of any one of the plurality of GUIs of FIGS. 12a to 33 disclosed below may include or be linked to one or more actions including, without limitation, links, prompts, buttons, sliders, radio boxes, keypads, icons, fill-in fields, graphics, dynamic graphics, pop-ups, fly-overs, maps, heat maps, expanders, contractors, graphs, charts, signature boxes, and the like. (NOTE: hereinbelow, text within brackets, e.g., “<logo>”, is not the actual text displayed but a field descriptive of the actual text displayed.)

FIG. 12a illustrates an exemplary “who they think you are” virtual footprint GUI screen 1200, according to some implementations of the current subject matter. FIG. 12b illustrates an exemplary “who your data suggests you are” virtual footprint GUI screen 1202, according to some implementations of the current subject matter. FIG. 12c illustrates another exemplary “who they (the machine(s)) think you are” virtual footprint GUI screen 1204, according to some implementations of the current subject matter.

The GUIs of FIGS. 12a-c, inclusive, may include one or more of the following outputs, inputs, text strings or prompts, which may be associated with one or more actions and/or links to one or more other GUIs: “Tap the layers to learn more”, “Who you really are”, “Who you data suggests you are”, “Who they think you are”, “What you share”, “What your behavior tells them”, “What the machine thinks about you”, “Gender”, “Search terms”, “Friends”, “User name”, “Likes & other reactions”, Uploaded photos”, “Real name”, Visited websites”, “Ads clicked”, “GPS”, “Shopping patterns”, “Typing speed”, “Articles/posts clicked”, “Timestamps”, “Ethnicity”, “Religious views”, “IQ”, “High/low self-esteem”, “Mental illness”, “Psychometric profile”, “Gambling”, and “View full virtual footprint”.

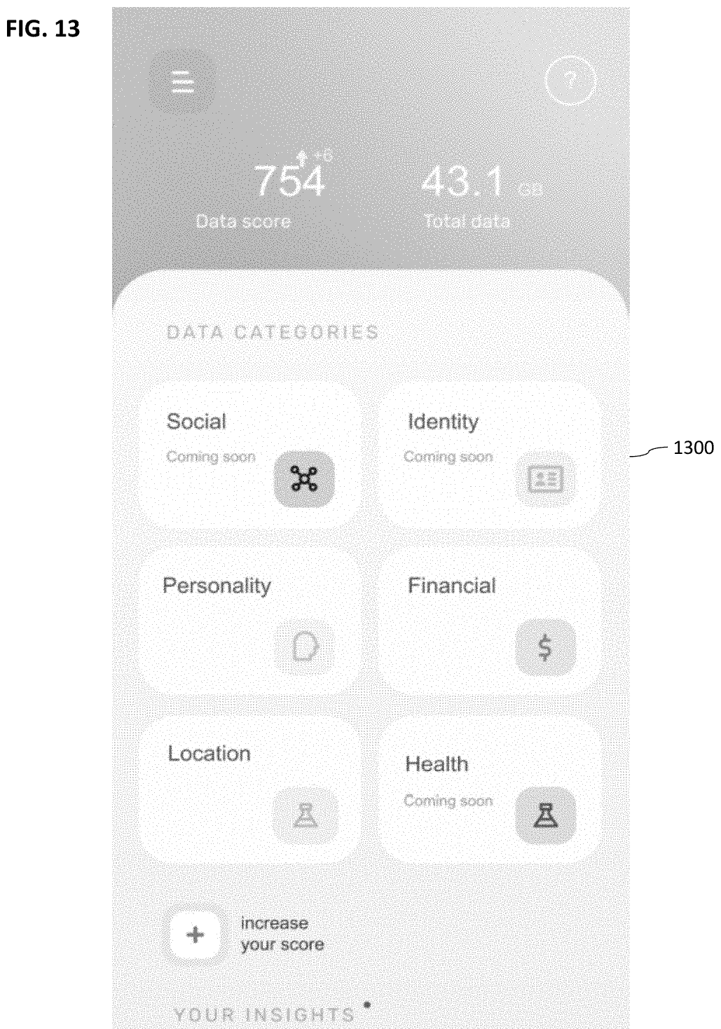

FIG. 13 is an exemplary home GUI screen 1300, according to some implementations of the current subject matter. The screen 1300 may be configured to indicate user's data score (and/or whether it increased, decreased, or is unchanged), total data, as well as various data categories (e.g., “Social”, “Financial”, etc.) from and/or into which data may be obtained, extracted, provided, supplied, updated, characterized, etc. The screen 1300 may also provide an opportunity to the user to increase their score by providing further data, etc., as described herein. In some implementations, any data supplied by the user and/or gathered by the current subject matter, may be audited (e.g., reviewed for accuracy). The audit may be performed automatically, manually, and/or both, and/or in any other fashion. The data may be audited in any desired category (e.g., personal, financial, business, social, emotional, etc.).

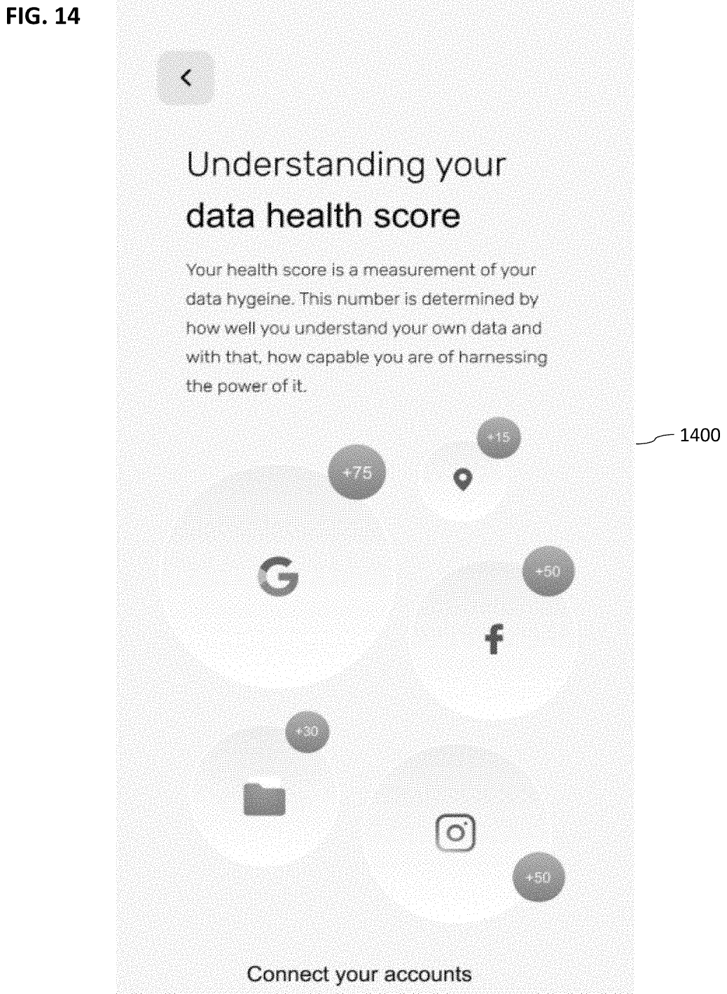

FIG. 14 is an exemplary “understanding data health score” GUI screen 1400, according to some implementations of the current subject matter. The GUI 1400 of FIG. 14 may include one or more of the following outputs, inputs, text strings or prompts, which may be associated with one or more actions and/or links to one or more other GUIs: “Understanding your data health score”, “and “Your health score is a measurement of your data hygiene.” The number may be determined by how well the user understands their own data and with that, how capable the user may be of harnessing the power of it. In some implementations, one or more of user's social, financial, educational, etc. accounts may be connected in determining the user's data score. A user interface (e.g., GUI 1400) may be used for illustrating how the data score has been computed, including, but not limited, factors, categories, etc. that were used in calculating the score.

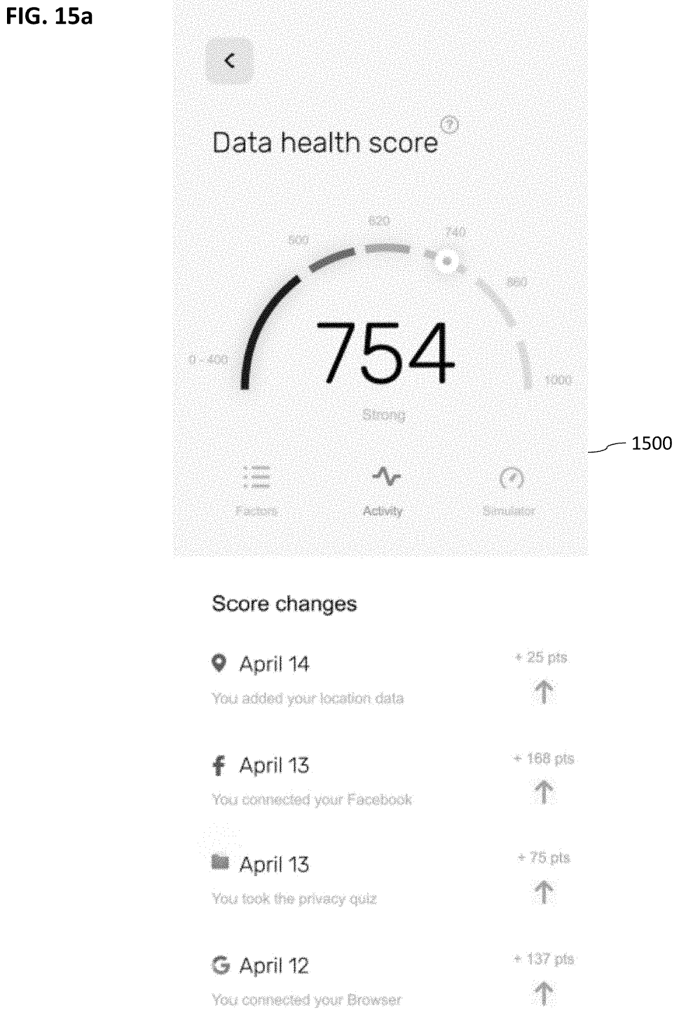

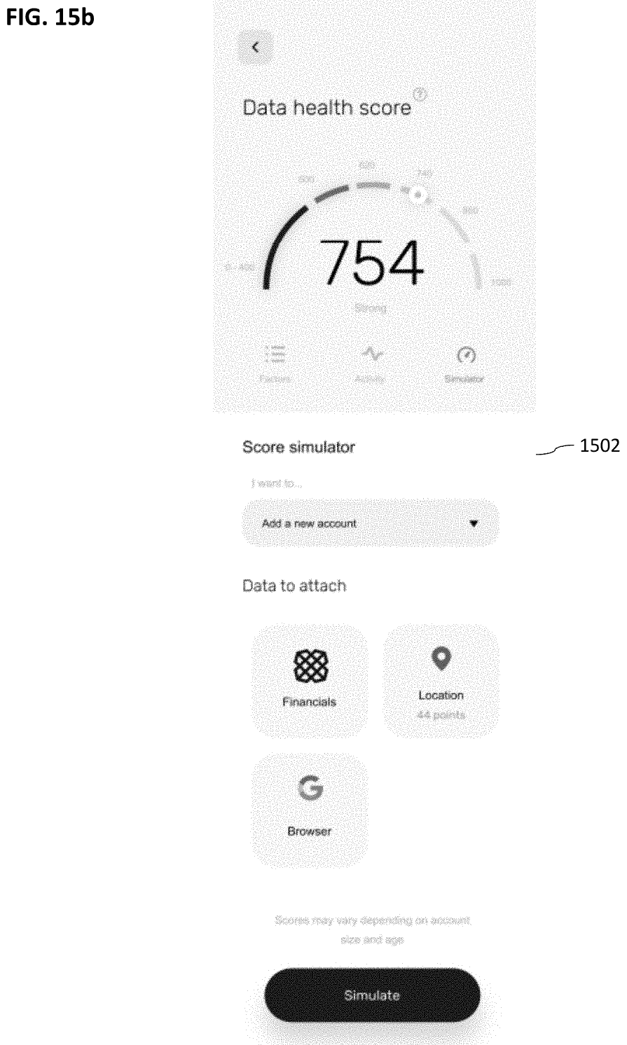

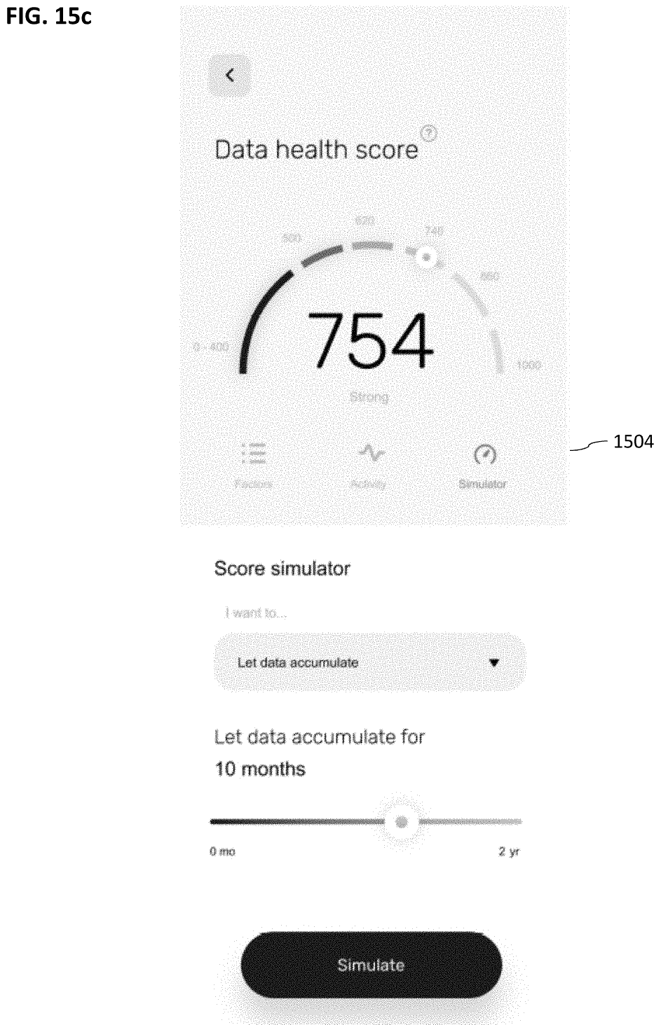

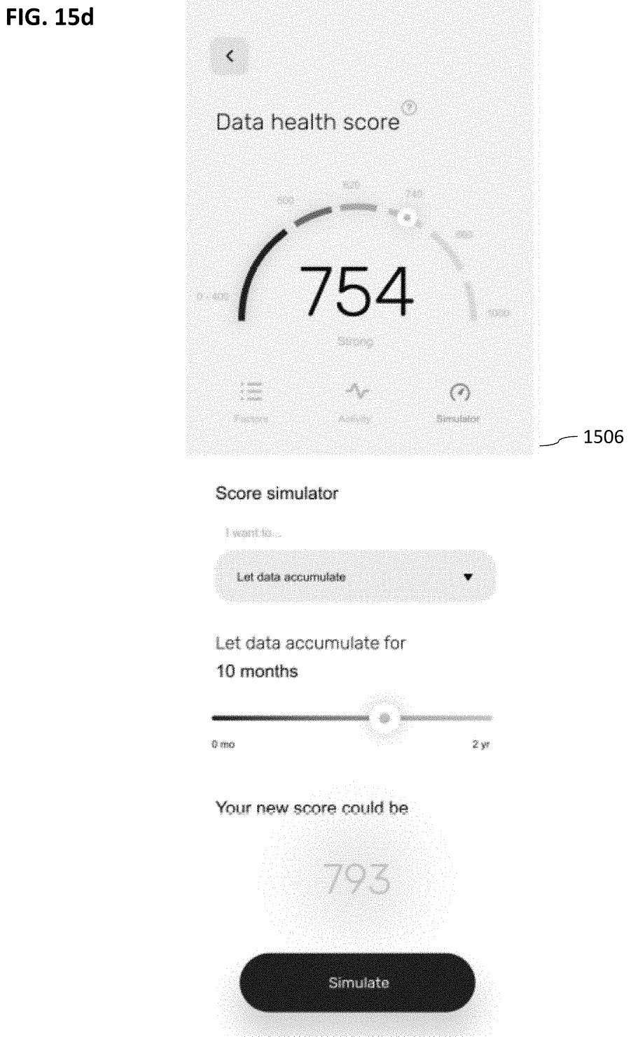

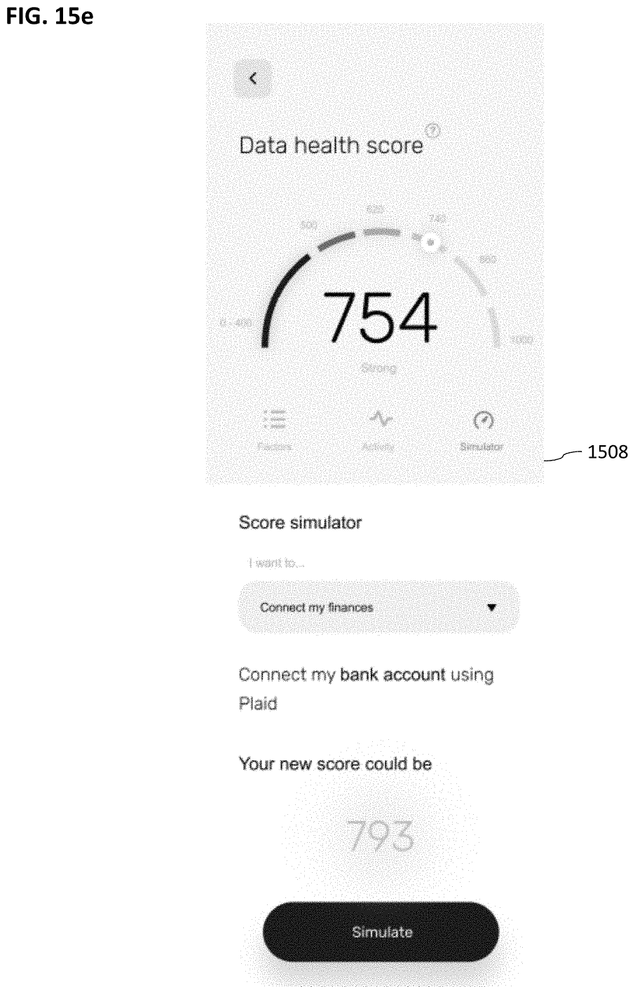

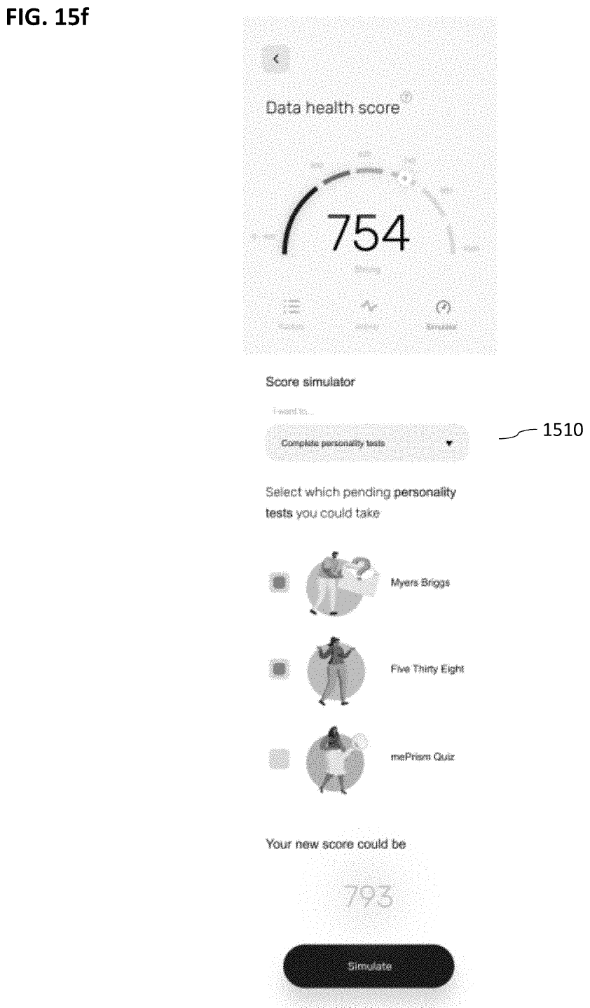

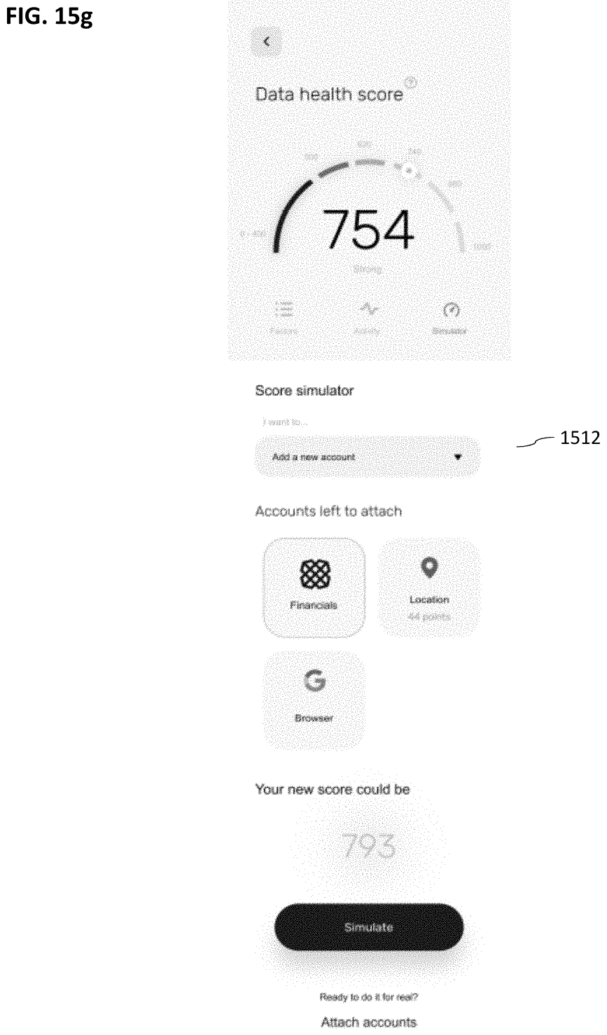

FIG. 15a is an exemplary data health score activity GUI screen 1502, according to some implementations of the current subject matter. FIG. 15b is an exemplary data health score predictor GUI screen 1504, according to some implementations of the current subject matter. FIG. 15c is another exemplary data health score predictor GUI screen 1506, according to some implementations of the current subject matter. FIG. 15d is yet another exemplary data health score predictor GUI screen 1508 without a call to action (CTA), according to some implementations of the current subject matter. FIG. 15e is still another exemplary data health score predictor GUI screen 1510 with a bank CTA, according to some implementations of the current subject matter. FIG. 15f is a further exemplary data health score predictor GUI screen 1512 with a personality test CTA, according to some implementations of the current subject matter. FIG. 15g is a still further exemplary data health score predictor GUI screen 1514 with several CTAs, according to some implementations of the current subject matter.

The GUIs of FIGS. 15a-g, inclusive, may include one or more of the following outputs, inputs, text strings or prompts, which may be associated with one or more actions and/or links to one or more other GUIs, which may be related to various data health score factors. The factors may related to data health score (e.g., 0-400, 500, etc.), strength of data health score (e.g., strong, weak, etc.), user activity information (e.g., addition of location data, etc.), connection of data from social media platforms, etc., as shown in FIGS. 15a-g.

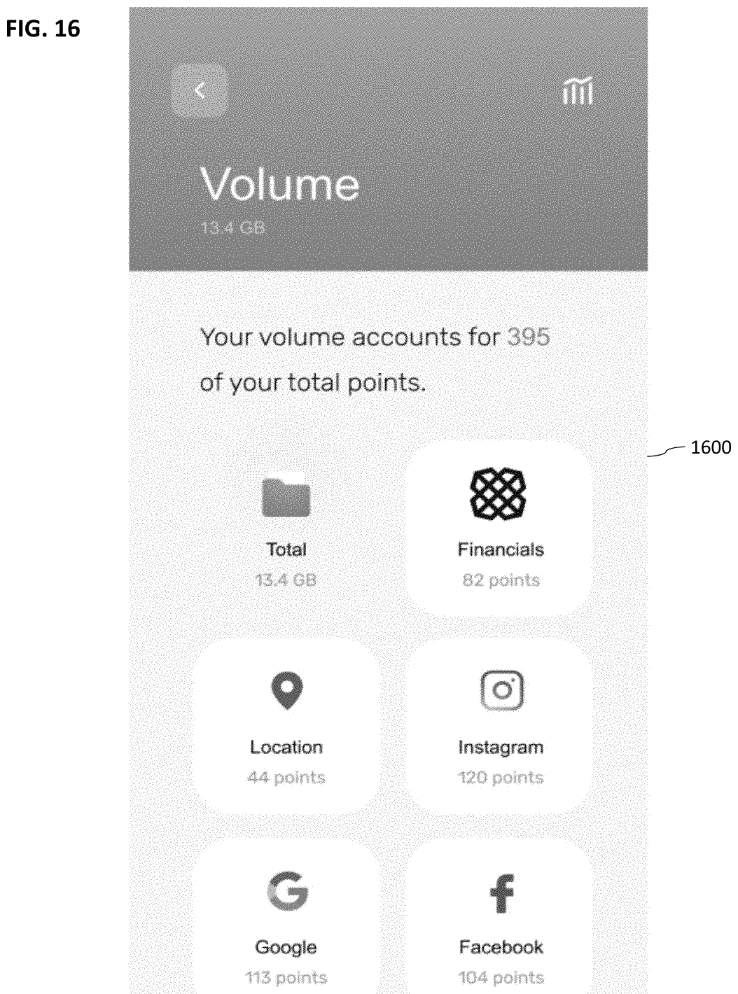

FIG. 16 illustrates an exemplary data volume GUI screen 1600, according to some implementations of the current subject matter. The GUI 1600 may include one or more outputs, inputs, text strings or prompts, which may be associated with one or more actions and/or links to one or more other GUIs. These may include, but are not limited, to a data volume (e.g., 13.4 GB) and corresponding point value (e.g., 395). The total point value may be broken down by various categories (e.g., financial—82 points, location—44 points, etc.). As can be understood, any other categories, point values, etc. may be used.

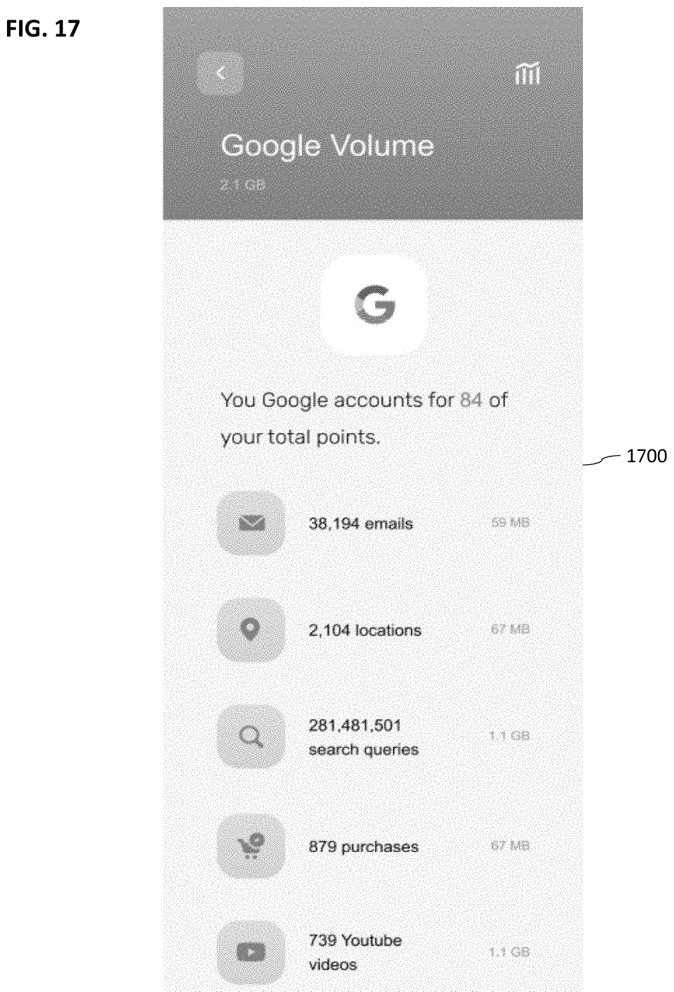

FIG. 17 is an exemplary data volume GUI screen 1700 (e.g., search engine, such as, GOOGLE), according to some implementations of the current subject matter. The GUI 1700 may include one or more outputs, inputs, text strings or prompts, which may be associated with one or more actions and/or links to one or more other GUIs. In this case, the volume of data may be broken down by various categories associated with a search engine, e.g., accounts, emails, locations, purchases, videos, etc.

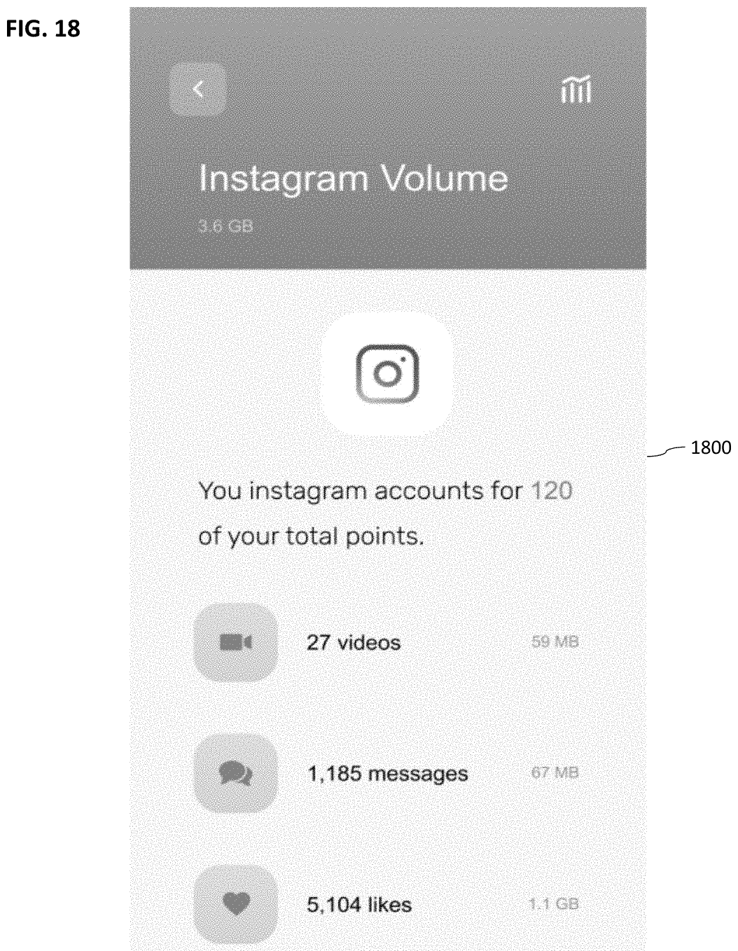

FIG. 18 is an exemplary data volume GUI screen 1800, according to some implementations of the current subject matter. The GUI 1800 may include one or more outputs, inputs, text strings or prompts, which may be associated with one or more actions and/or links to one or more other GUIs. The GUI 1800 may display data volume and/or any associated point values related various social medial accounts.

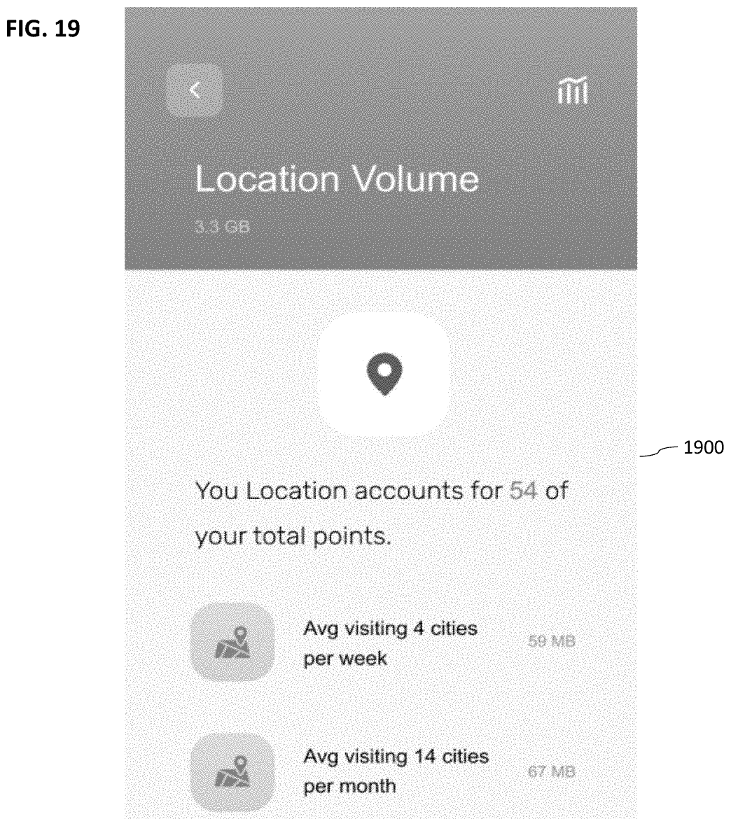

FIG. 19 is an exemplary location data volume GUI screen 1900, according to some implementations of the current subject matter. The GUI 1900 may include one or more outputs, inputs, text strings or prompts, which may be associated with one or more actions and/or links to one or more other GUIs. The GUI 1900 may display data volume and/or any associated point values related various travel activities, for example.

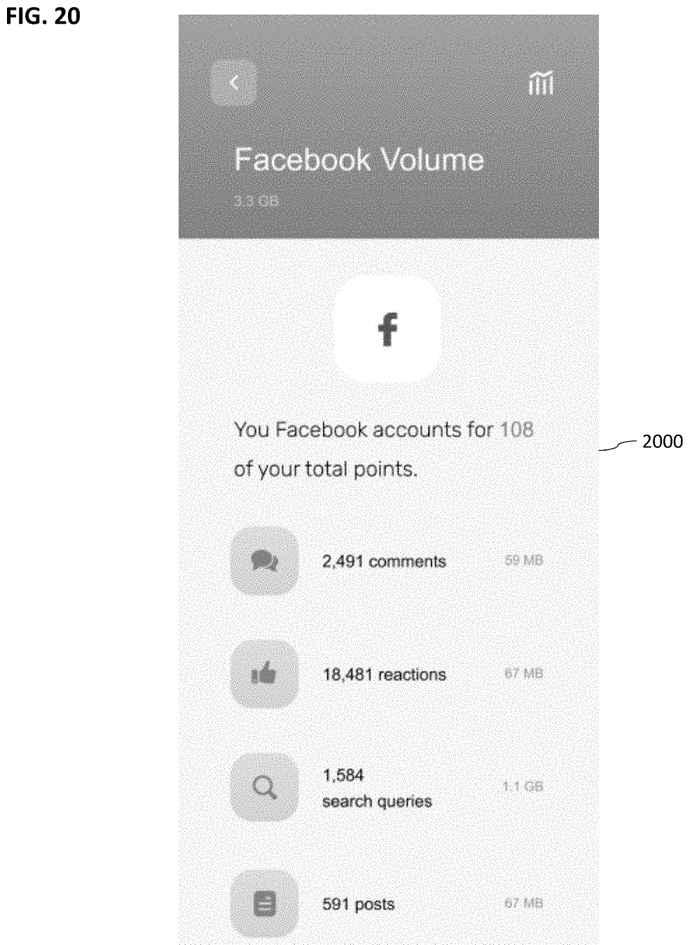

FIG. 20 is an exemplary social media data volume GUI screen 2000, according to some implementations of the current subject matter. The GUI 2000 may include one or more outputs, inputs, text strings or prompts, which may be associated with one or more actions and/or links to one or more other GUIs. In particular, the GUI 2000 may indicate data volume associated with one or more user's accounts on social media platforms, websites, etc. (e.g., comments, reactions, search queries, posts, etc.), along with corresponding point volume.

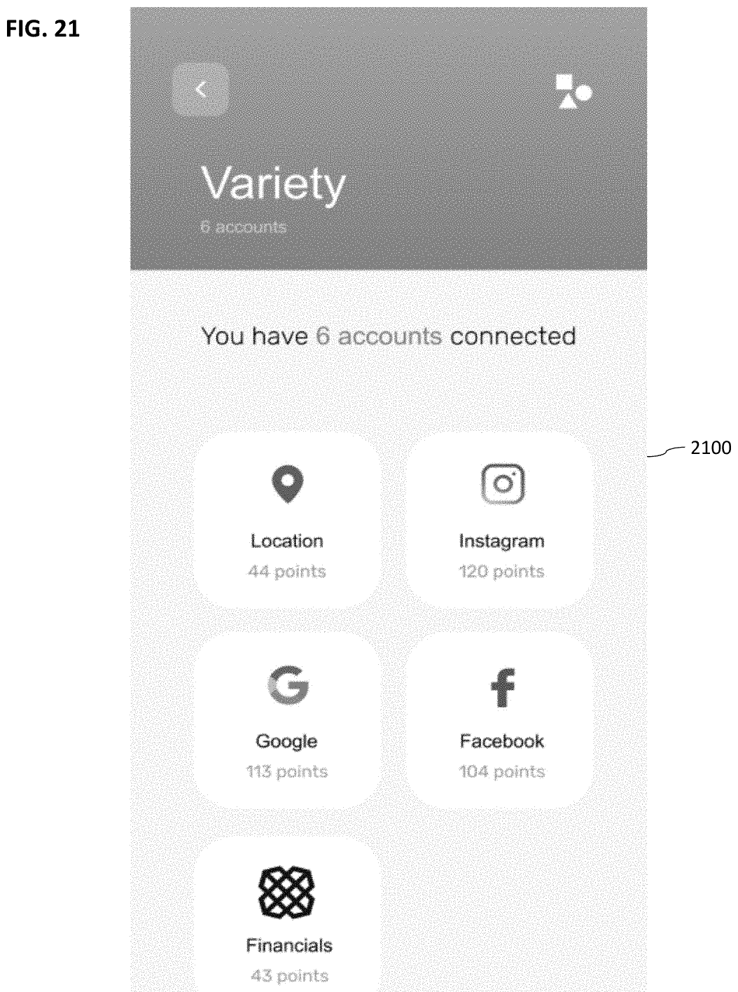

FIG. 21 is an exemplary account variety GUI screen 2100, according to some implementations of the current subject matter. The GUI 2100 may include one or more outputs, inputs, text strings or prompts, which may be associated with one or more actions and/or links to one or more other GUIs. Specifically, GUI 2100 may illustrate variety of user's accounts (e.g., that may be connected), locations, photos, search engines, etc.

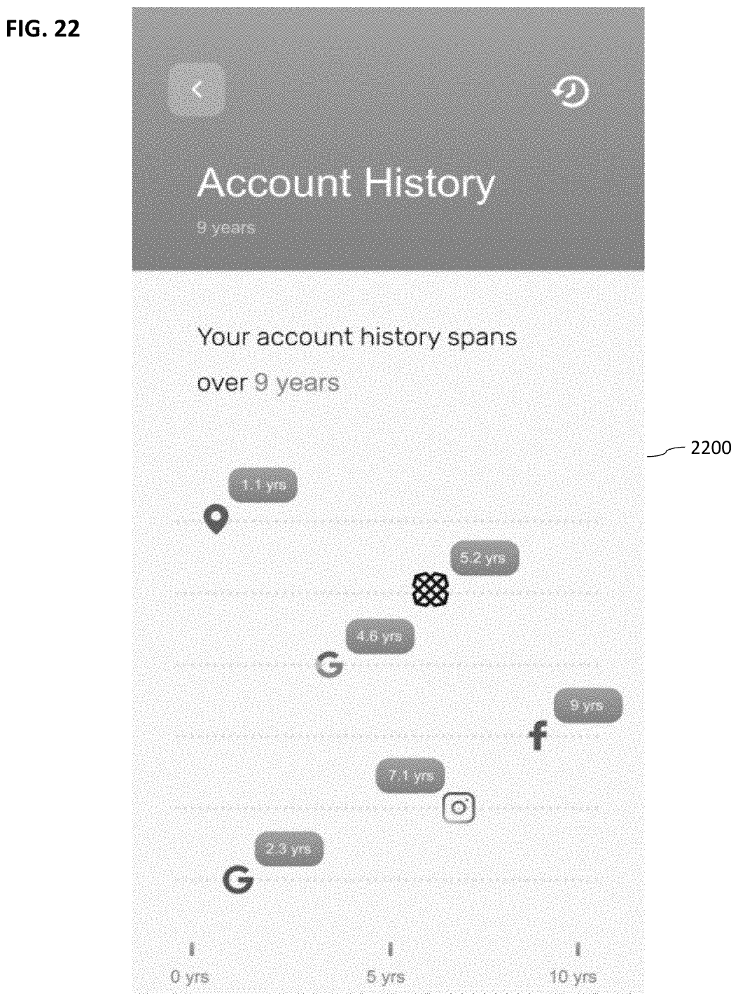

FIG. 22 is an exemplary account history GUI screen 2200, according to some implementations of the current subject matter. The GUI 2200 may include one or more outputs, inputs, text strings or prompts, which may be associated with one or more actions and/or links to one or more other GUIs. The GUI 2200 may illustrate ages of various user accounts.

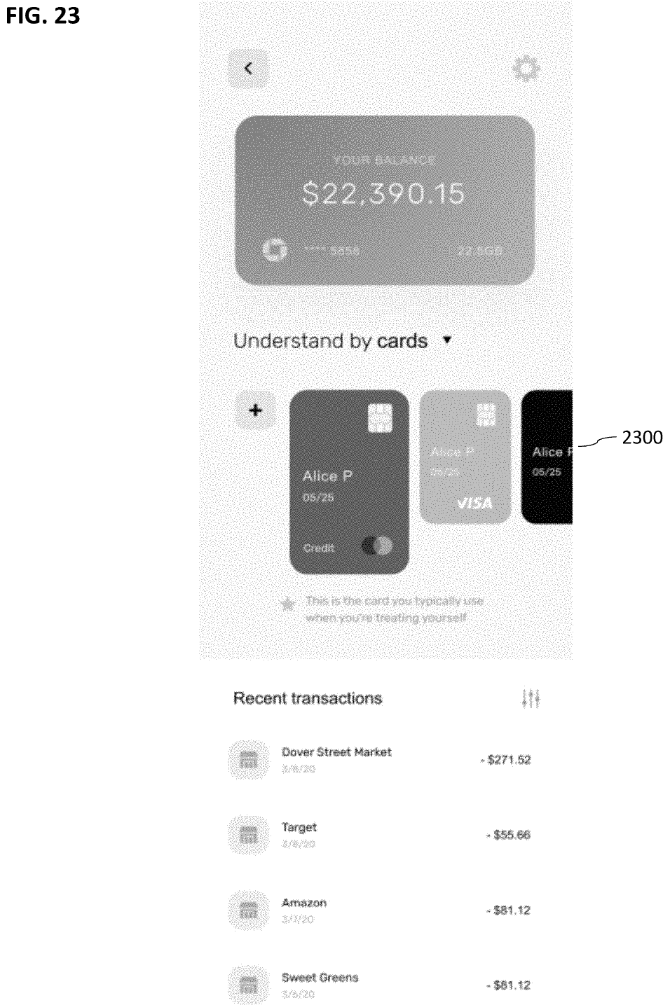

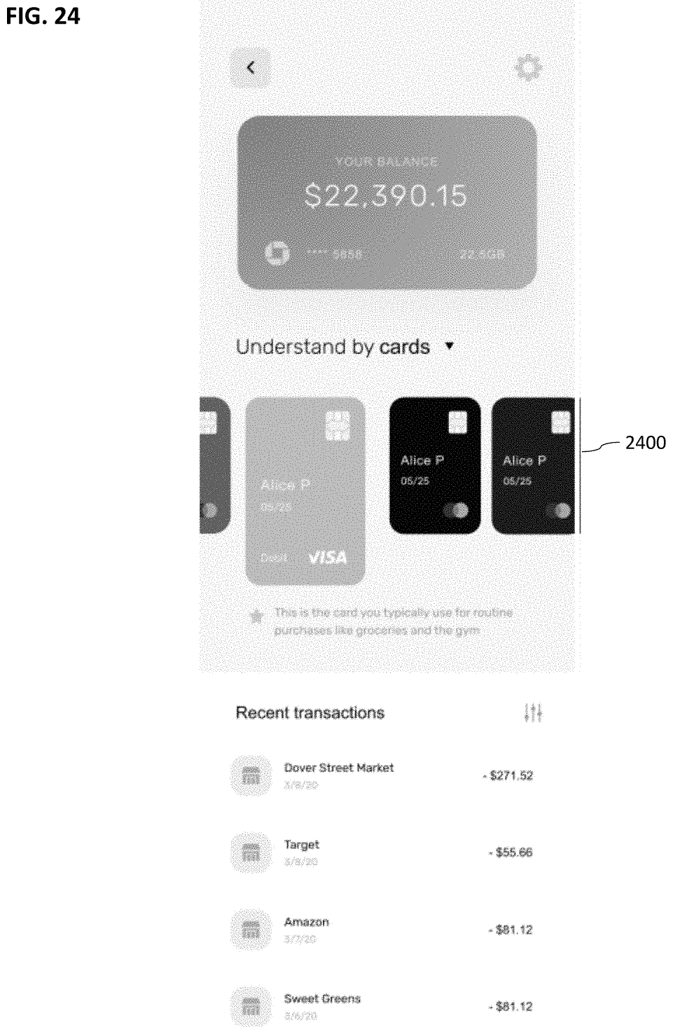

FIG. 23 illustrates an exemplary financial summary GUI screen 2300, according to some implementations of the current subject matter. FIG. 24 is another exemplary financial summary GUI screen 2400 with sliding financial cards, according to some implementations of the current subject matter.

The GUIs of FIGS. 23 and 24 may include one or more outputs, inputs, text strings or prompts, which may be associated with one or more actions and/or links to one or more other GUIs. The GUIs 2300 and 2400 may illustrate various balances on user accounts, types of financial cards (e.g., credit, debit, etc.), etc., as well as display associated data volumes. The screens may also illustrate user's habits (e.g., shopping locations, types of stores, types of purchases, transaction information, etc.).

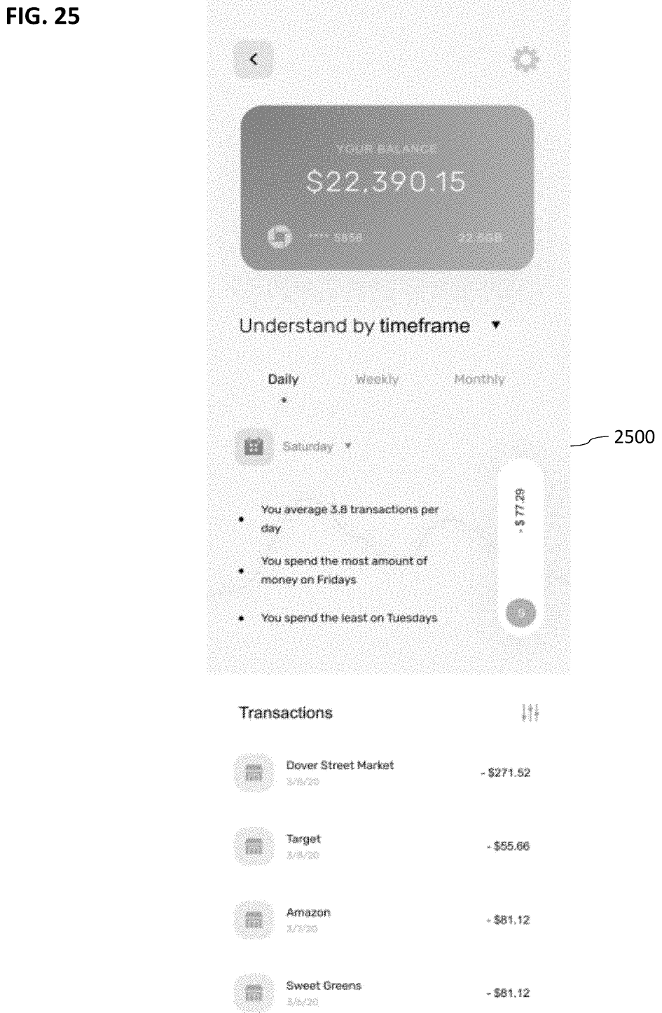

FIG. 25 illustrates an exemplary daily spending GUI screen 2500, according to some implementations of the current subject matter. The GUI 2500 may include one or more outputs, inputs, text strings or prompts, which may be associated with one or more actions and/or links to one or more other GUIs. The GUI 2500 may provide additional details with regard to financial transactions by the user, including, but not limited, to time, location, amount spent (e.g., most, least), etc.

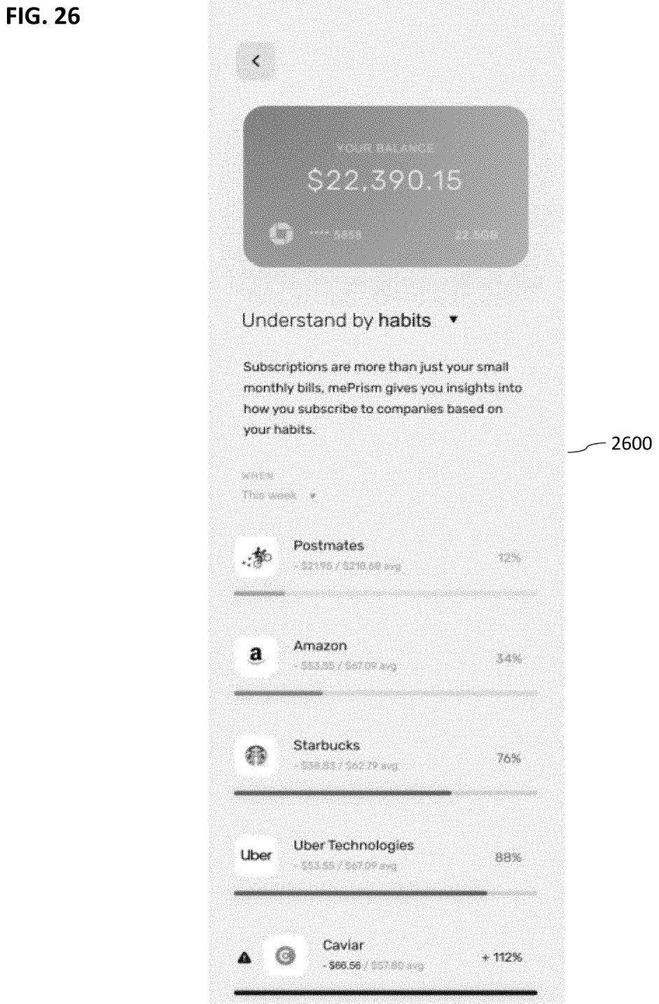

FIG. 26 is an exemplary financial habits GUI screen 2600, according to some implementations of the current subject matter. The GUI 2600 may include one or more outputs, inputs, text strings or prompts, which may be associated with one or more actions and/or links to one or more other GUIs. Specifically, the GUI 2600 may further breakdown user's spending habits.

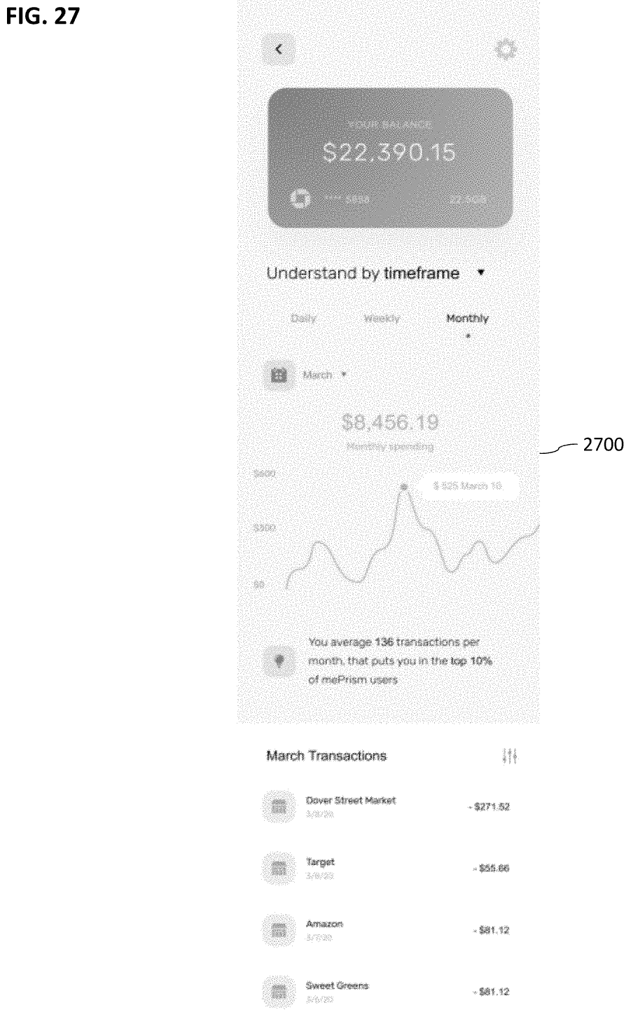

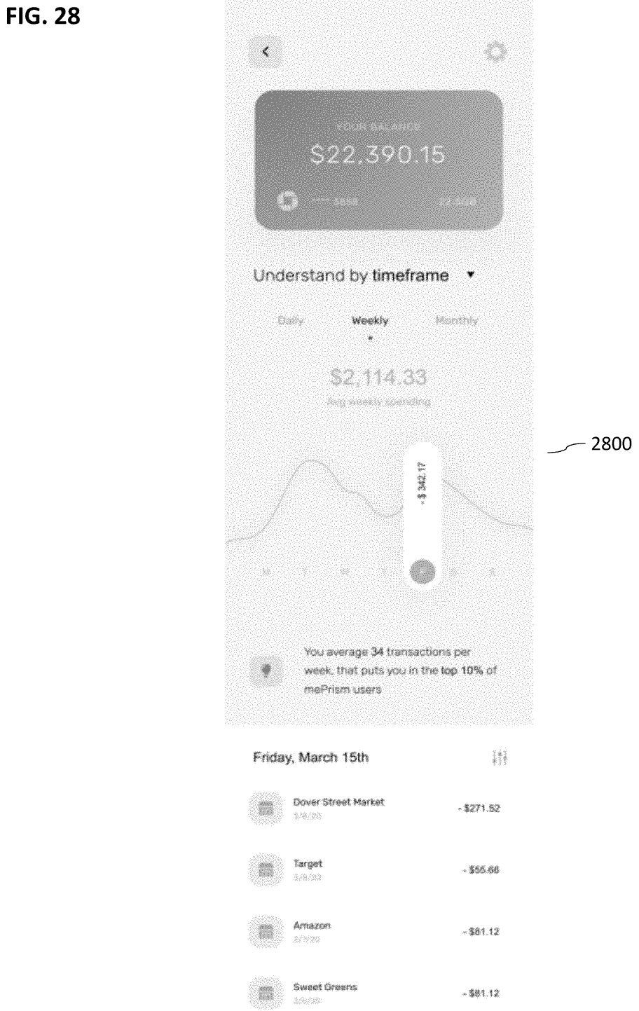

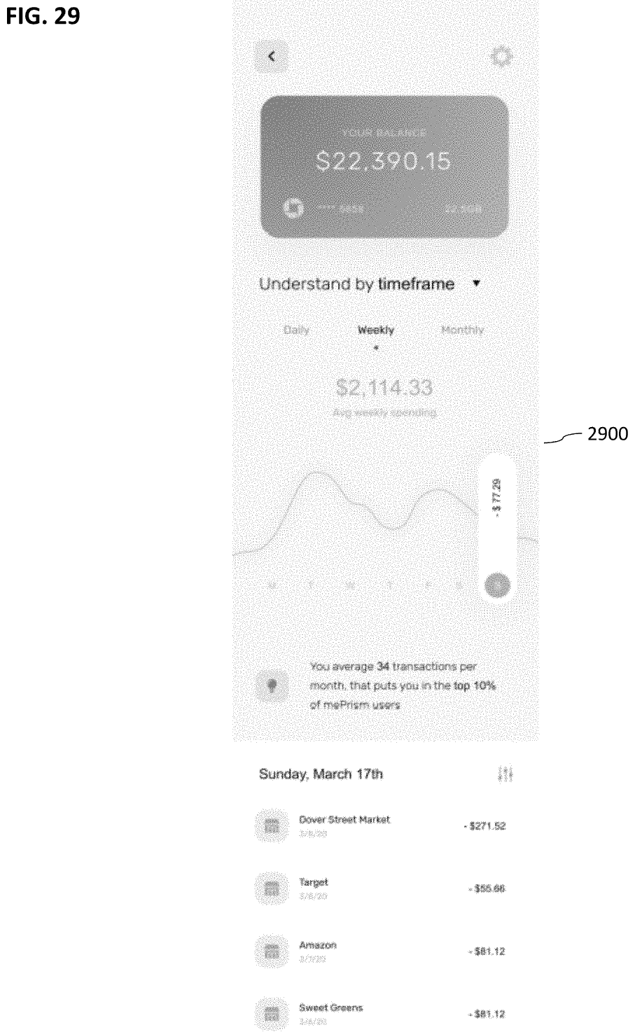

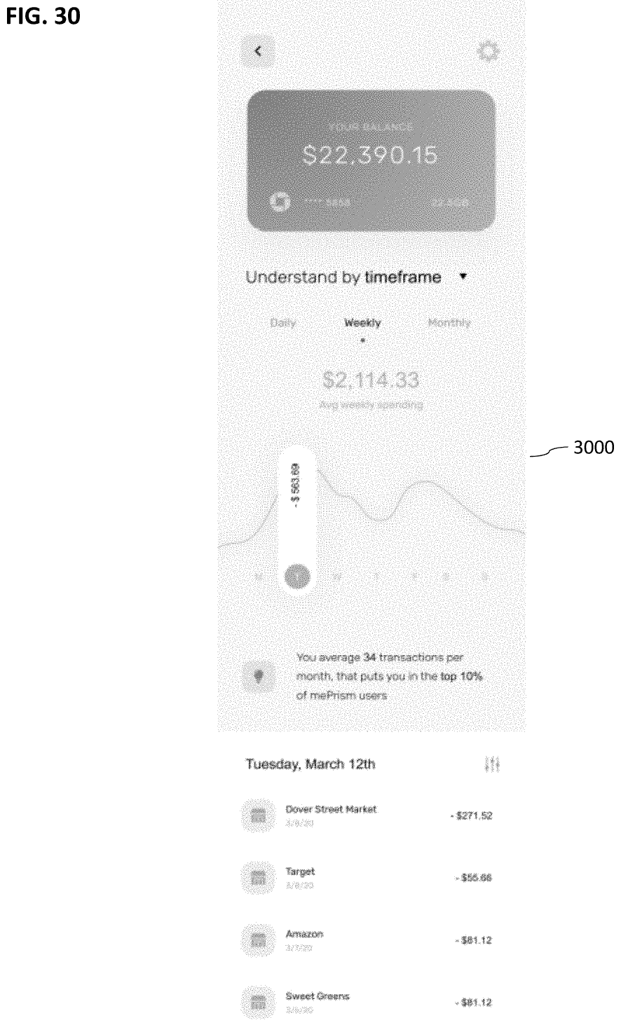

FIG. 27 is an exemplary financial timeframe (monthly) GUI screen 2700, according to some implementations of the current subject matter. FIG. 28 is an exemplary financial timeframe (weekly) GUI screen 2800, according to some implementations of the current subject matter. FIG. 29 is another exemplary financial timeframe (weekly) GUI screen 2900, according to some implementations of the current subject matter. FIG. 30 is yet another exemplary financial timeframe (weekly) GUI screen 3000, according to some implementations of the current subject matter.

The GUIs of FIGS. 27-30, inclusive, may include one or more outputs, inputs, text strings or prompts, which may be associated with one or more actions and/or links to one or more other GUIs. In particular, GUIs 2700-3000 may include further analysis of spending patterns, changes in spending patterns, timeframes associated with the spending patterns, etc.

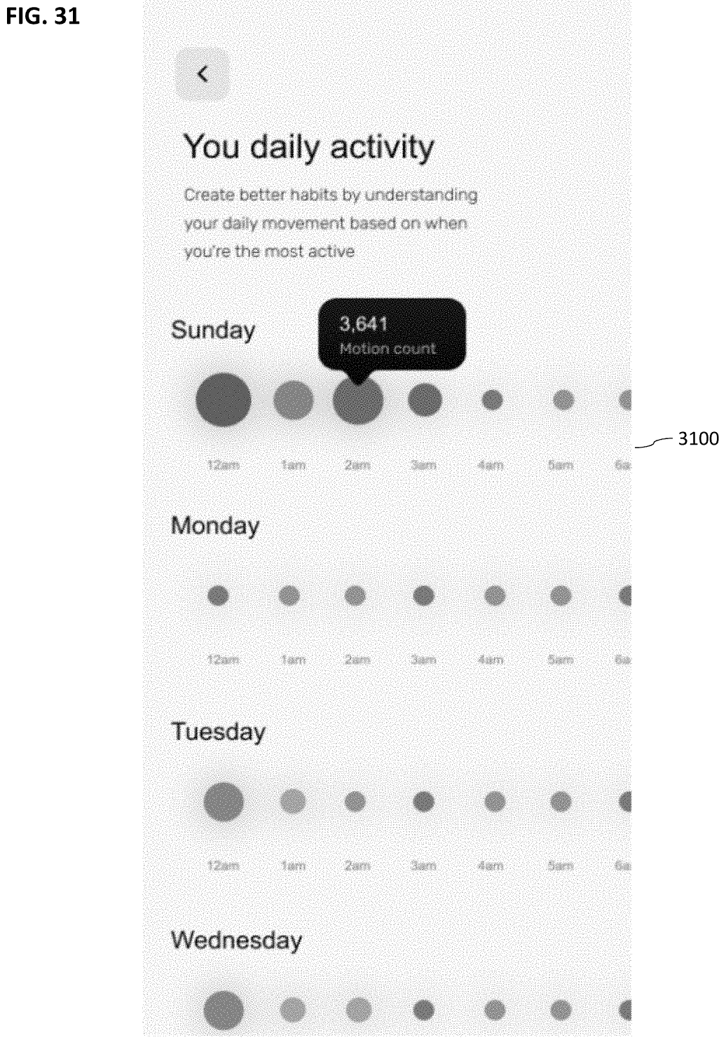

FIG. 31 illustrates an exemplary version of the daily activity heat map GUI screen 3100, according to some implementations of the current subject matter. The GUI 3100, inclusive, may include one or more outputs, inputs, text strings or prompts, which may be associated with one or more actions and/or links to one or more other GUIs. The GUI 3100 may display user activities in a form of a heat map that may be broken down by days of the week, month, times of day, etc.

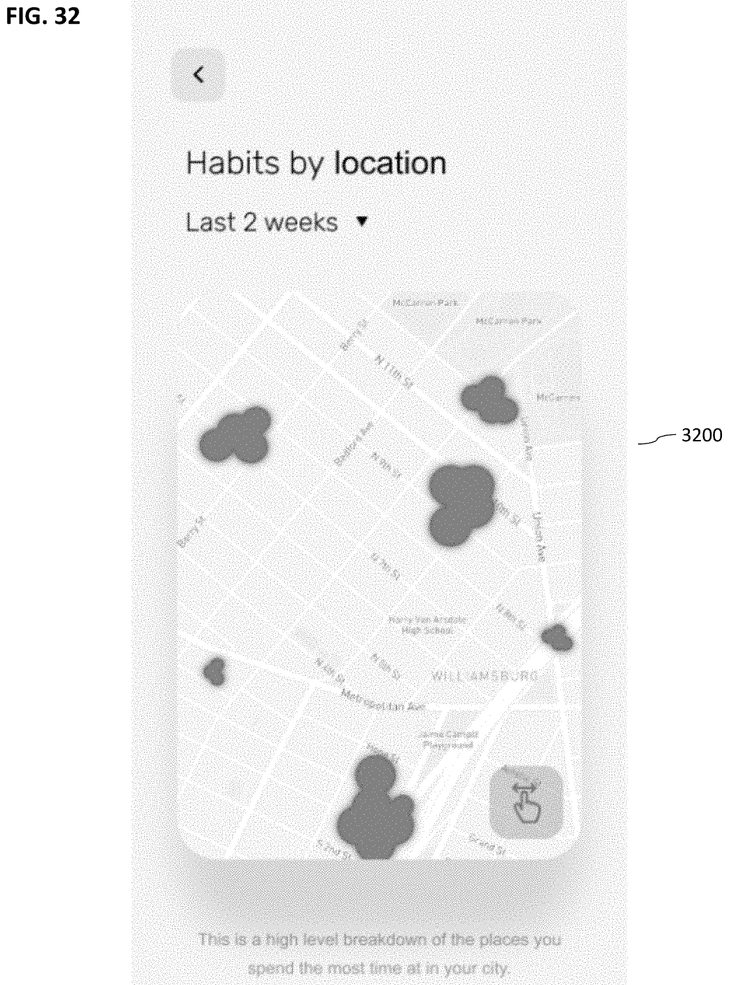

FIG. 32 is an exemplary hotspot location GUI screen 3200, according to some implementations of the current subject matter. The GUI 3200 may be configured to display user's spending habits by specific location, time, etc.

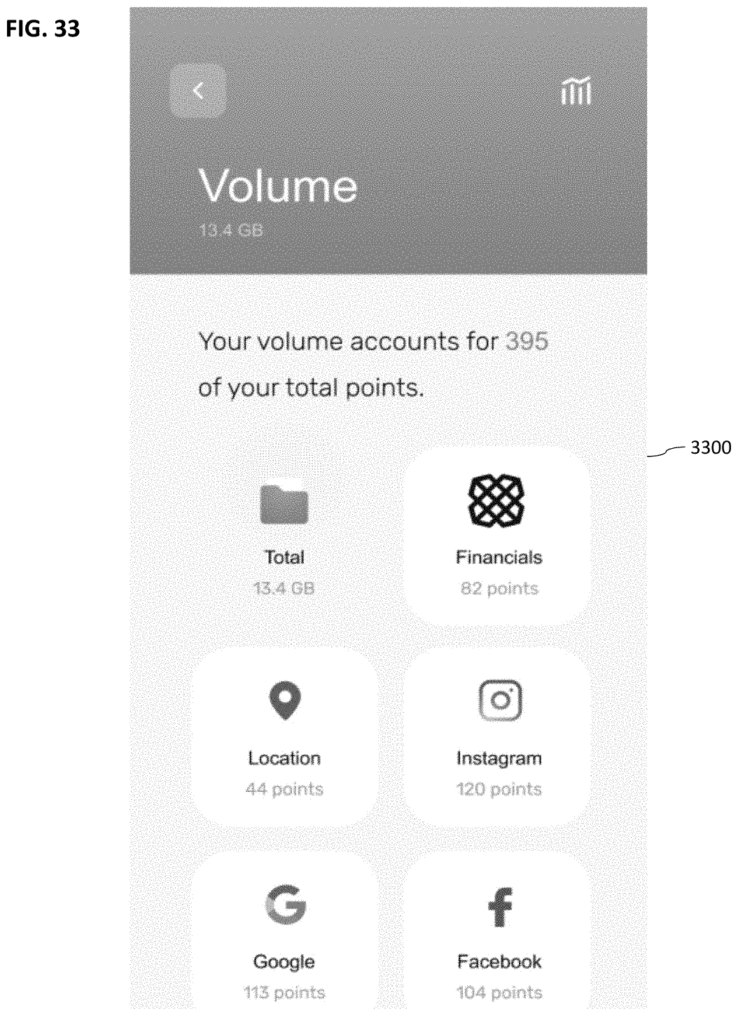

FIG. 33 is another exemplary data volume home GUI screen 3300, according to some implementations of the current subject matter. The GUI 3300 may include one or more outputs, inputs, text strings or prompts, which may be associated with one or more actions and/or links to one or more other GUIs. The GUI 3300 may information about user's data, such as, for example, data volume, associated point value, as well as a breakdown of point values by one or more categories. The GUI 3300 may displayed to the user to illustrate how user's analyzed activities affect user's total data volume, total point volume, as well as health data score.

Each of the above identified modules or programs corresponds to a set of instructions for performing a function described above. These modules and programs (i.e., sets of instructions) need not be implemented as separate software programs, procedures or modules, and thus various subsets of these modules may be combined or otherwise re-arranged in various embodiments. In some embodiments, memory may store a subset of the modules and data structures identified above. Furthermore, memory may store additional modules and data structures not described above.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on at least one integrated circuit (IC) chip. For example, in one embodiment, a set of components can be implemented in a single IC chip. In other embodiments, at least one of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that at least one component may be combined into a single component providing aggregate functionality or divided into several separate sub-components, and any at least one middle layer, such as a management layer, may be provided to communicatively couple to such sub-components in order to provide integrated functionality. Any components described herein may also interact with at least one other component not specifically described herein but known by those of skill in the art.

In addition, while a particular feature of the subject innovation may have been disclosed with respect to only one of several implementations, such feature may be combined with at least one other feature of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with at least one specific functionality. For example, a component may be, but is not limited to being, a process running on a processor (e.g., digital signal processor), a processor, an object, an executable, a thread of execution, a program, and/or a computer. By way of illustration, both an application running on a controller and the controller can be a component. At least one component may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer-readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by at least one local or remote computing device, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has at least one of its characteristics set or changed in such a manner as to encode information in at least one signal. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be appreciated that the methodologies disclosed in this specification are capable of being stored on an article of manufacture to facilitate transporting and transferring such methodologies to computing devices. The term article of manufacture, as used herein, is intended to encompass a computer program accessible from any computer-readable device or storage media.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although at least one exemplary embodiment is described as using a plurality of units to perform the exemplary process, it is understood that the exemplary processes may also be performed by one or plurality of modules.

The use of the terms “first”, “second”, “third” and so on, herein, are provided to identify various structures, dimensions or operations, without describing any order, and the structures, dimensions or operations may be executed in a different order from the stated order unless a specific order is definitely specified in the context.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein may be embodied in systems, apparatus, methods, and/or articles depending on the desired configuration. The embodiments set forth in the foregoing description do not represent all embodiments consistent with the subject matter described herein. Instead, they are merely some examples consistent with aspects related to the described subject matter. Although a few variations have been described in detail above, other modifications or additions are possible. In particular, further features and/or variations may be provided in addition to those set forth herein. For example, the embodiments described above may be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other embodiments may be within the scope of the following claims.

What is claimed is:

1. A computer-implemented method for collecting, structuring, and storing personal data of a user of an online service, the method comprising:
collecting, by at least one processor, a personal data of a user from an online service;
structuring, by the at least one processor, the collected personal data;
storing, by the at least one processor, the structured collected personal data in a structured unitary data structure in at least one memory location, wherein the structured unitary data structure is configured to store at least one of the following: a customer data, a search engine data, a social media data, a contract customer data, an enterprise customer data, and a contract data;
querying, by the at least one processor, the structured unitary data structure; and
transmitting, by the at least one processor, a response to the query.

2. The method according to claim 1, wherein the structured unitary data structure is configured to interrelate at least two of the following: the customer data, the search engine data, the social media data, the contract customer data, the enterprise customer data, and the contract data.

3. The method according to claim 1, wherein the structured unitary data structure is configured to store customer meta data.

4. The method according to claim 1, wherein the structured unitary data structure is configured to aggregate customer information.

5. The method according to claim 1, wherein the structured unitary data structure is configured to track a state of activity at any point within an architecture.

6. The method according to claim 1, wherein the structured unitary data structure is configured to provide a flexible access pattern and a document structure.

7. The method according to claim 1, wherein the structured unitary data structure is configured to control structure, indexing, and reliability.

8. The method according to claim 1, wherein the structured unitary data structure complies with an industry standard.

9. The method according to claim 1, wherein the structured unitary data structure is configured for loose coupling, high cohesion, and without multi-collection operational access.

10. The method according to claim 1, wherein the structured unitary data structure is configured to keep data from third party sources separate from other internal and third party sources.

11. The method according to claim 1, wherein the structured unitary data structure is configured to separate data lake structures from operational data structures.

12. The method according to claim 1, wherein the structured unitary data structure is configured to maintain a high cohesion and a close data relation in the unitary data structure.

13. The method according to claim 12, wherein the structured unitary data structure is configured to balance the high cohesion with a loose coupling.

14. The method according to claim 13, wherein the structured unitary data structure is configured to assign a higher priority to the loose coupling relative to the high cohesion.

15. The method according to claim 1, wherein the structured unitary data structure is configured to avoid access of operational services to more than one collection directly.

16. The method according to claim 1, wherein the structured unitary data structure comprises at least one of the following a customer master database, a first online service takeout database, a second online service takeout database, a contract customer database, an enterprise data customer database, and a contract database.

17. The method according to claim 1, wherein the structured unitary data structure comprises a one-to-many relationship.

18. The method according to claim 16, wherein the structured unitary data structure comprises the customer master database in the one-to-many relationship between the first online service takeout database.

19. The method according to claim 16, wherein the structured unitary data structure the customer master database in the one-to-many relationship with the second online service takeout database.

20. The method according to claim 16, wherein the structured unitary data structure comprises the customer master database in the one-to-many relationship with the contract customer database.

21. The method according to claim 16, wherein the structured unitary data structure comprises the enterprise data customer database in the one-to-many relationship with the contract customer database.

22. The method according to claim 16, wherein the structured unitary data structure comprises the enterprise data customer database in the one-to-many relationship with the contract database.

23. The method according to claim 1, wherein the structured unitary data structure comprises a primary key, and a foreign key.

24. The method according to claim 1, further comprising
prompting the user for access to the online service; and
accessing the online service on behalf of the user.

25. The method according to claim 1, wherein the structuring the collected personal data includes analyzing one or more portions of the personal data of the user from at least one of the following: a social media, a personality, a finance, a location, and a health, and
the method further comprising
displaying to the user an option to access the analysis of the at least one of the following: the social media, the personality, the finance, the location, and the health.

26. The method according to claim 1, further comprising
analyzing the collected personal data.

27. The method according to claim 1, further comprising
calculating a data score based on the analyzed collected personal data; and
displaying the data score,
wherein the calculating the data score based on the analyzed collected personal data includes at least one of the following: a volume factor based on a size of the personal data of the user from the online service a variety factor based on the number of the plurality of online services, an account history factor based on an age of the personal data of the user from the online service, a psychometric factor based on user responses to questions, and any combination thereof.

28. The method according to claim 1,
wherein the online service is a plurality of online services,
wherein the plurality of online services includes at least one of the following a financial service, a location service, a social media service, and a search engine, and
wherein the calculating the data score based on the analyzed collected personal data includes at least one of the following: a weighted average of points for each of plurality of online services, a simulator configured to display to the user a new data score based on addition of a new online service, and any combination thereof.

29. The method according to claim 1, wherein the data score is a numeric value.

30. The method according to claim 1, wherein the data score is displayed with a meter, wherein the meter includes a numeric range corresponding with the data score.

31. The method according to claim 1, further comprising at least one of the following:
displaying to the user an option to sell at least one portion of the analyzed collected personal data based on the data score;
prompting the user to accept a license to a buyer of at least one portion of the analyzed collected personal data;
calculating a value of the analyzed collected personal data based on the data score; and
transmitting an offer for sale of at least one portion of the analyzed collected personal data to an entity other than the user.

32. The method according to claim 1, further comprising
receiving from an entity other than the user a bid for purchase of at least one portion of the analyzed collected personal data; and
transmitting the bid to the user.

33. The method according to claim 1, further comprising
receiving from a plurality of advertisers bids for purchase of at least one portion of the analyzed collected personal data; and
displaying to the user a grid comparing the bids from the plurality of advertisers.

34. The method according to claim 1, further comprising rendering at least one of the following:
content to the user based on the analyzed collected personal data;
emotional content to the user based on emotional data extracted from the analyzed collected personal data;
emotional content to the user based on emotional data extracted from the analyzed collected personal data including display of at least one portion of the personal data corresponding with the rendered emotional content;
a virtual footprint to the user based on the analyzed collected personal data, wherein the virtual footprint includes personal information regarding the user extracted from the analyzed collected personal data;
a virtual footprint to the user based on the analyzed collected personal data, wherein the virtual footprint includes content based on information the user shares, content based the personal data that suggests attributes of the user, and content derived from a machine analysis of the personal data; and
a virtual footprint to the user based on the analyzed collected personal data, wherein the virtual footprint includes content based on one or more of gender, search terms, friends, user name, likes, reactions, photos, real name, ethnicity, religious views, intelligence quotient, self-esteem, mental illness, psychometric profile, gambling, visited websites, advertisements, global positioning system, shopping patterns, typing speed, clicks, articles, posts, timestamps;
a data dose to the user, wherein the data dose includes a prediction based on the analyzed collected personal data;
a daily activity summary to the user, wherein the data activity summary includes a heat map including data corresponding with at least one of the following a day of the week, a time of the day, a geographic location, and a mode of transportation.

35. The method according to claim 1, further comprising
prompting the user to verify an accuracy of information based on the analyzed collected personal data.

36. A system for collecting, structuring, and storing personal data of a user of an online service, the system comprising:
at least one processor; and
a memory storing at least one program for execution by the at least one processor, the at least one program including instructions, when, executed by the at least one processor cause the at least one processor to perform operations comprising:
collecting a personal data of a user from an online service;
structuring the collected personal data;
storing the structured collected personal data in a structured unitary data structure, wherein the structured unitary data structure is configured to store at least one of the following: a customer data, a search engine data, a social media data, a contract customer data, an enterprise customer data, and a contract data;
querying the structured unitary data structure; and
transmitting a response to the query.

37. A non-transitory computer-readable storage medium storing at least one program for collecting, structuring, and storing personal data of a user of an online service, the at least one program for execution by at least one processor and a memory storing the at least one program, the at least one program including instructions, when, executed by the at least one processor cause the at least one processor to perform operations comprising:
collecting a personal data of a user from an online service;
structuring the collected personal data;
storing the structured collected personal data in a structured unitary data structure, wherein the structured unitary data structure is configured to store at least one of the following: a customer data, a search engine data, a social media data, a contract customer data, an enterprise customer data, and a contract data;
querying the structured unitary data structure; and
transmitting a response to the query.
